(19) United States
(12) Patent Application Publication
(10) Pub. No.: US 2011/0090237 A1
(43) Pub. Date: Apr. 21, 2011

(54) INFORMATION CONVERSION METHOD, INFORMATION CONVERSION APPARATUS, AND INFORMATION CONVERSION PROGRAM

(75) Inventors: Kenta Shimamura, Hyogo (JP); Po-Chieh Hung, Tokyo (JP); Tomoaki Tamura, Tokyo (JP)

(73) Assignee: KONICA MINOLTA HOLDINGS, INC.,, Tokyo (JP)

(21) Appl. No.: 12/996,537

(22) PCT Filed: May 29, 2009
(86) PCT No.: PCT/JP2009/059861

§ 371 Date: Dec. 6, 2010

(30) Foreign Application Priority Data
Jun. 9, 2008 (JP) 2008-150889

(51) Int. Cl. G09G 5/02; G09G 5/00

(52) U.S. Cl. 345/582; 345/589

(57) ABSTRACT

Provided is an information conversion method including: a first area extracting step which extracts a first area constituting a dot, a line or a character in a displayable area of the original image data; a first area color extracting step which extracts a color of the first area; a second area determining step which decides a second area constituting a periphery of the first area; and an image processing step which generates an intensity modulation element in which the intensity has been modulated in accordance with the color of the first area if the first area color is a predetermined color and adds the intensity modulation element to the second area or the first and the second areas for output.

This is a U.S. national stage application of International Application No. PCT/JP2009/059861, filed on 29 May 2009. Priority under 35 U.S.C. §119(a) and 35 U.S.C. §365(b) is claimed from Japanese Application No. 2008-150889, filed 9 Jun. 2008, the disclosure of which is also incorporated herein by reference.

### TECHNICAL FIELD

The present invention relates to information conversion methods, information conversion apparatuses, and information conversion programs.

### TECHNICAL BACKGROUND

Having weak color vision means having a weak part for recognition/discrimination of color compared with a person with general color vision because of difference of a cone cell for recognizing color.

Here, weak color vision persons, as is described in Table 9.1 “Classifications of weak color vision persons and abbreviated symbols for them” (p. 189) of “Fundamentals of Color Engineering” authored by Mitsuo Ikeda, Asakura Shoten, are classified according to the photoreceptor cells of red (L cone cells), green (M cone cells), and blue (S cone cells), and according to their sensitivities.

A person who does not have any one type of cone cell or whose cone cell has different sensitivity is called a weak color vision person. In the case of an L cone cell, the weak color vision person is classified into a P-type weak color vision person, in case of an M cone cell, classified into a D-type weak color vision person, and in case of an S cone cell, classified into a T-type weak color vision person.

When any of the sensitivities is low, they are respectively classified into types PA, DA, and TA. The color vision characteristics of types P, D, and T weak color vision persons are such that, as is described in FIG. 9.13 “Color confusion line of dichromatic weak color vision persons” (p. 205) of “Fundamentals of Color Engineering” authored by Mitsuo Ikeda, Asakura Shoten, the colors present on this line (color confusion line) appear as a completely identical color, and it is not possible to distinguish between them (see FIG. 30).

Such weak color vision persons cannot distinguish between the colors of an image viewed by a general color vision person in the same manner, and hence image display or image conversion is necessary for weak color vision persons. Proposals for this type of weak color vision have been made in the following patent document and non-patent document.

Further, a phenomenon similar to that of weak color vision can occur even for general color vision persons under light sources with restricted spectral distributions. Further, this phenomenon can also occur when photographing using a camera.

For this type of weak color vision, the proposal has been made according to the following patent document and non-patent document.

### PRIOR ART DOCUMENT

### Patent Document

Patent Document 1: Unexamined Japanese Patent Application Publication No. 2004-178513.

Patent Document 2: Japanese Translation of PCT International Application Publication No. 2007-512915.

### Non-Patent Document

Non-patent Document 1: SmartColor (K. Wakita and K. Shimamura, SmartColor: disambiguation framework for the colorblind. In Assets '05: Proc. Of the 7th international ACM SIG ACCESS conference on computers and accessibility, pages 158-165, NY, USA, 2005.

### SUMMARY OF THE INVENTION

### Problems to be Solved by the Invention

The technology described in the above Non-patent Document 1 improves the ease of distinguishing by changes in the color by converting the display into colors that can be distinguished by weak color vision persons. In this case, since there is a trade-off relationship between the amount of color change for weak color vision persons and the colors recognized by general color vision persons, when conversion is made into colors that can be recognized by weak color vision persons, the color changes largely, and there will be a big change in the impression from the original display.

Because of this, it is difficult to share documents between general color vision persons and weak color vision persons. Although there is a setting of making the color change as low as possible, in that case, there is not much improvement in the ease of distinguishing for weak color vision persons. In addition, since the color which is changed is determined according to the content of the color of the display, there is a big problem that the original color changes for a general color vision person.

The technology described in the above Patent Document 1 not only classifies the display data into those for which color/shape conversion is made and those for which this conversion is not made, but also, further classifications are made in terms of the shape such as dots, lines, surfaces, a table is possessed that has the predetermined shapes corresponding to the colors, and the result of this classification is converted into shapes by referring to the table.

In the above Patent Document 1, the method of determining the shape is arbitrary, and the system is such that the interpretation is made by referring to a legend.

Since the colors in the color space are made to be distinguished by shapes for each surface, line, or dot, there is the problem that the candidates for shapes become insufficient. Further, since the ease of distinguishing the shapes does not have correlation with the ease of distinguishing the original colors, there will be a big difference in the ease of distinguishing among objects relative to general color vision persons, the feelings cannot be shared with general color vision persons. In this case, there is a problem that conspicuousness becomes different.

In addition, when an object that is of a single color is converted into a shape, there is often an increase into plural colors, and therefore it becomes possible to distinguish from an object of the roughly the same color because of plural colors, however in that case even if one color is maintained to be the original color, the overall color of the object becomes a synthesis of plural colors, and can sometimes become different from the original color.

In addition to this, since there is no clear rule for the parameters of the color and determining the shape, the person seeing the display cannot understand the correspondence between colors and shapes unless there is a legend, and it is not possible to interpret the type of color. Even when there is a legend, it is difficult to establish the correspondence.

Since there is no common part in the methods of determining the shapes respectively for dots, lines and surfaces, it becomes more difficult. Further when a line and a surface are lapped, there is a problem that the region cannot be determined.

The technology described in Patent Document 2 is an apparatus that photographs the subject and converts it into the display so that it can be distinguished by a weak color vision person. This is a method in which the areas with roughly the same color as the (one or more) colors of the locations specified by the user within the photographed subject are made to be distinguished from other areas. A distinguishing method using texture or blinking is described.

In the above Patent Document 2, the method of determining the shape is arbitrary, and the details in the concrete example given have not been described.

Firstly, since the ease of distinguishing the shapes is not correlated with the ease of distinguishing the original colors, the ease of distinguishing between objects is largely different from those of general color vision persons, and it is not possible to share the feelings with general color vision persons. Also in this case, there is a problem that conspicuousness becomes different.

In addition, the original color cannot be maintained. When an object of a single color is converted into a shape, there is often an increase into plural colors, and therefore, it becomes possible to distinguish from an object of the roughly the same color because of plural colors, however in that case even if one color is maintained to be the original color, the overall color of the object becomes a synthesis of plural colors, and can sometimes become different from the original color.

In addition to this, since there is no clear rule for the parameters of the color and determining the shape, the person seeing the display cannot understand the correspondence between colors and shapes unless there is a legend, and it is not possible to interpret the type of color. Even when there is a legend, it is difficult to establish the correspondence.

The above problems occur when the object is pigmented with a color which is difficult to be recognized by a weak color vision person and a similar case happens when a dot, thin line or character having its small area is intended to be accentuated by a color.

The present invention is for solving the above problems and an object of the present invention is to solve the problem such as a color-coded display not being recognized by the weak color vision person and the original color not being retained for the general color vision person by means of a state suitable for observation of both a general color vision person and a weak color vision person, even for a small dot, a thin line or a thin character.

Further, an object is to provide an information conversion method, information conversion apparatus and information conversion program which realize image display communicating color information before monochrome conversion even after the monochrome conversion.

### Means for Solving the Problems

The present invention to solve the above problems is as follows.

(1) The item 1 as an embodiment of the present invention is an information conversion method including a first area extraction step for extracting a first area constituting a dot, a line, or a character, in a displayable area of original image data; a first area color extraction step for extracting a color of the first area; a second area determination step for determining a second area surrounding the first area; and an image processing step for generating an intensity modulation element whose intensity has been modulated in accordance with the color of the first area, and for adding the intensity modulation element in the second area, or the first and the second areas for output.

(2) The item 2 as an embodiment of the present invention is the information conversion method according to the above item 1, wherein, in the first area extraction step, when the width of the dot, line or a line constituting the character is a certain value or less compared to the spatial wavelength of the intensity modulation element, the dot, line or character is extracted as the first area.

(3) The item 3 as an embodiment of the present invention is the information conversion method according to the above item 1 or 2, wherein the intensity modulation element is a texture including a pattern or hatching, varied in accordance with a difference in the original colors when the colors are different but perceived similar to a perceiver.

(4) The item 4 as an embodiment of the present invention is the information conversion method according to the above item 1 or 2, wherein the intensity modulation element is a texture including a pattern or hatching, having a different inclination in accordance with a difference in the original colors when the colors are different but perceived similar to a perceiver.

(5) The item 5 as an embodiment of the present invention is the information conversion method according to one of the above items 1 to 4, wherein the intensity modulation element changes the intensity of the color while keeping its chromaticity.

(6) The item 6 as an embodiment of the present invention is an information conversion apparatus including a first area extraction section for extracting a first area constituting a dot, a line, or a character, in a displayable area of original image data; a first area color extraction section for extracting a color of the first area; a second area determination section for determining a second area surrounding the first area; an intensity modulation processing section for generating an intensity modulation element whose intensity has been modulated in accordance with the color of the first area through an intensity modulation process; and an image processing section for adding the intensity modulation element in the second area, or the first and the second areas for output.

(7) The item 7 as an embodiment of the present invention is the information conversion apparatus according to the above item 6, wherein, in the first area extraction section, when the width of the dot, line or a line constituting the character is a certain value or less compared to the spatial wavelength of the intensity modulation element, the dot, line or character is extracted as the first area.

(8) The item 8 as an embodiment of the present invention is the information conversion apparatus according to the above item 6 or 7, wherein the intensity modulation element is a texture including a pattern or hatching, varied in accordance with a difference in the original colors when the colors are different but perceived similar to a perceiver.

(9) The item 9 as an embodiment of the present invention is the information conversion apparatus according to the above item 6 or 7, wherein the intensity modulation element is a texture including a pattern or hatching, having a different inclination in accordance with a difference in the original colors when the colors are different but perceived similar to a perceiver.

(10) The item 10 as an embodiment of the present invention is the information conversion apparatus according to one of the above items 6 to 9, wherein the intensity modulation element changes the intensity of the color while keeping its chromaticity.

(11) The item 11 as an embodiment of the present invention is an information conversion program for allowing a computer to function as the first area extraction section for extracting the first area constituting a dot, line or character, in the displayable area of original image data; the first area color extraction section for extracting a color of the first area; the second area determination section for determining the second area surrounding the first area; the intensity modulation processing section for generating the intensity modulation element whose intensity has been modulated in accordance with the color of the first area through the intensity modulation process; and the image processing section for adding the intensity modulation element in the second area, or the first and the second areas for output.

### EFFECTS OF THE INVENTION

According to the information conversion method, the information conversion apparatus, and the information conversion program of the present invention, the following effects can be obtained.

The present invention extracts the first area constituting a dot, line, or character, in the displayable area of original image data, extracts a color of the first area, determines the second area surrounding the first area, generates the intensity modulation element whose intensity has been modulated in accordance with the color of the first area, and adds the intensity modulation element in the second area, or the first and the second areas for output.

In this way, the intensity modulation element in accordance with the color of the first area is added to the second area, or the intensity modulation element in accordance with the color of the first area is added to the first and the second areas to create a state suitable for both a general color vision person and a weak color vision person so that problems can be solved, such as a color-coded display not being recognized by the weak color vision person and the original color not being retained for the general color vision person.

In addition, when the width of the dot, line or a line constituting the character is a certain value or less compared to the spatial wavelength of the intensity modulation element, for example, when the rate of the dot, line or character with respect to the displayable area is a certain value or less, or when the size of the dot, line or character is a certain size or less, the dot, line or character is extracted as the first area to create a state suitable for both a general color vision person and a weak color vision person so that problems associated with a small dot, a thin line, or a thin character can be solved, such as a color-coded display not being recognized by the weak color vision person and the original color not being retained for the general color vision person.

When the original colors are different but the light receiving result is similar at a light receiving side, a texture including a pattern or hatching, varied in accordance with the difference in the original colors, is used as the intensity modulation element to create a state suitable for observation of both a general color vision person and a weak color vision person so that the original color information can be communicated. Furthermore, if the data is converted to monochrome for output, the original color information still can be communicated.

When the original colors are different but the light receiving result is similar at a light receiving side, a texture including a pattern or hatching, having a different angle in accordance with the difference in the original colors, can be used as the intensity modulation element to create a state suitable for observation of both a general color vision person and a weak color vision person so that the original color information can be communicated. That is, by defining an angle by associating it with chromaticity in advance, the original color information can be memorized and difference in colors can be continuously recognized without referring to a legend. Furthermore, if the data is converted to monochrome for output, the original color information still can be communicated.

The intensity modulation element changes the intensity of the color while keeping its chromaticity, that is, the average color in the area where the element is added is unchanged from the original color or similar to the original color so that, preferably, a general color vision person is not disturbed and the original appearance is retained.

It is also preferable that the chromaticity be not changed from the original color in order to retain the original appearance.

Further, the ability to distinguish is enhanced further by making said textures have patterns or hatching with different angles according to the differences in the original colors. In addition, by defining the angles in advance, it becomes possible to memorize, and to distinguish the differences in color continuously without having to refer to a legend.

Further, the ability to distinguish is enhanced further by making said textures have different contrasts according to the differences in the original colors.

Further, the ability to distinguish is enhanced further by making said textures change with time according to the differences in the original colors.

Further, the ability to distinguish is enhanced further by making said textures move in different directions according to the differences in the original colors.

Further, the ability to distinguish is enhanced further by making said textures have a combination of two or more from among patterns or hatching with different angles according to the differences in the original colors, different contrasts according to the differences in the original colors, change with time or movement at different speeds according to the differences in the original color, and movement in different directions or with different speeds according to the differences in the original colors.

Further, it becomes possible to distinguish finely close to the original colors by making said textures have continuously changing conditions according to the differences in the original color.

### BRIEF DESCRIPTIONS OF TILE DRAWINGS

FIG. 1 is a flow chart showing the operation of the first preferred embodiment of the present invention.

FIG. 2 is a block diagram showing the configuration of the first preferred embodiment of the present invention.

FIGS. 3a to 3c are explanatory diagrams showing some examples of textures of the first preferred embodiment of the present invention.

FIGS. 4a to 4e are explanatory diagrams showing a chromaticity diagram and examples of applying textures in the first preferred embodiment of the present invention.

FIGS. 5a and 5b are explanatory diagrams of the first preferred embodiment of the present invention.

FIGS. 6a to 6e are explanatory diagrams of the first preferred embodiment of the present invention.

FIGS. 7a to 7g are explanatory diagrams of the second preferred embodiment of the present invention.

FIGS. 8a to 8g are explanatory diagrams of the second preferred embodiment of the present invention.

FIG. 9 is an explanatory diagram of the position in the chromaticity diagram in the third preferred embodiment of the present invention.

FIG. 10 is an explanatory diagram of the changes in the parameters in the third preferred embodiment of the present invention.

FIG. 11 is a block diagram showing the configuration of the third preferred embodiment of the present invention.

FIGS. 12a to 12c are explanatory diagrams showing some examples of the duty ratios of hatching in the third preferred embodiment of the present invention.

FIGS. 13a to 13c are explanatory diagrams showing some examples of the angles of hatching in the third preferred embodiment of the present invention.

FIG. 14 is a flow chart showing the movement of the fourth preferred embodiment of the present invention.

FIG. 15 is a block diagram showing the configuration of the fourth preferred embodiment of the present invention.

FIG. 16 is an explanatory diagram describing the fourth preferred embodiment of the present invention.

FIG. 17 is an explanatory diagram describing the fourth preferred embodiment of the present invention.

FIG. 18 is an explanatory diagram describing the fourth preferred embodiment of the present invention.

FIG. 19 is an explanatory diagram describing the fourth preferred embodiment of the present invention.

FIG. 20 is an explanatory diagram describing the fourth preferred embodiment of the present invention.

FIG. 21 is an explanatory diagram describing the fourth preferred embodiment of the present invention.

FIGS. 22a and 22b are explanatory diagrams describing the fourth preferred embodiment of the present invention.

FIGS. 23a and 23b are explanatory diagrams describing the fourth preferred embodiment of the present invention.

FIGS. 24a and 24b are explanatory diagrams describing the fourth preferred embodiment of the present invention.

FIGS. 25a and 25b are explanatory diagrams describing the fourth preferred embodiment of the present invention.

FIGS. 26a and 26b are explanatory diagrams describing the fourth preferred embodiment of the present invention.

FIGS. 27a and 27b are explanatory diagrams describing the fourth preferred embodiment of the present invention.

FIG. 28 is an explanatory diagram describing the fourth preferred embodiment of the present invention.

FIG. 29 is an explanatory diagram describing the fourth preferred embodiment of the present invention.

FIGS. 30a to 30c are explanatory diagrams describing the form of weak color vision.

### BEST MODE FOR CARRYING OUT THE INVENTION

Some best modes (hereinafter referred to as preferred embodiments) to carry out the present invention are described in detail below with reference to the drawings.

### [A] First Embodiment

### (A1) Configuration of an Information Conversion Apparatus

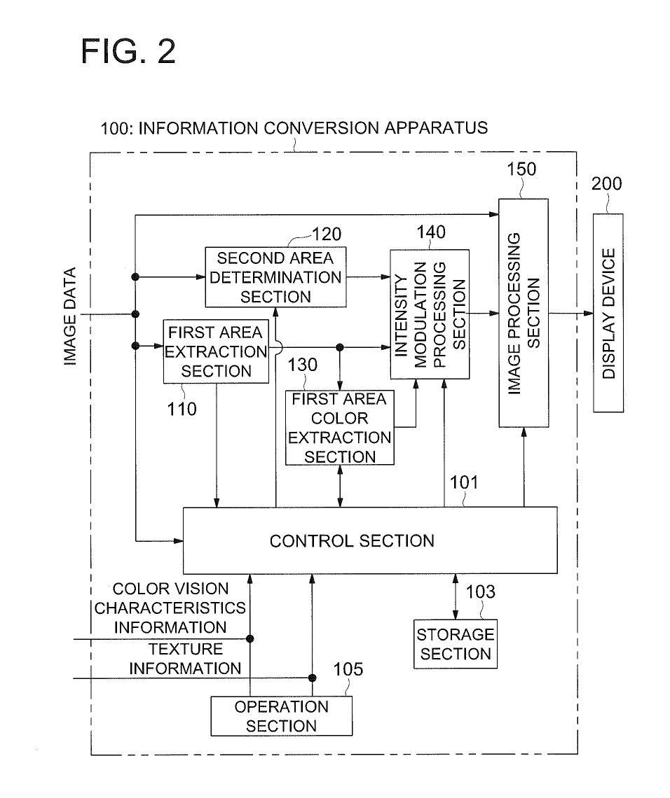

FIG. 2 is a block diagram showing the detailed configuration of an information conversion apparatus 100 according to a first preferred embodiment of the present invention.

The block diagram of the present information conversion apparatus 100 also expresses the processing procedure of the information conversion method, and each routine of the information conversion program.

Further, in FIG. 2, the periphery of the parts that are necessary for describing the operation of the present preferred embodiment have been shown, and the other types of items such as a power supply switch, power supply circuit, that are well known as parts of an information conversion apparatus 100 have been omitted.

The information conversion apparatus 100 according to a present preferred embodiment is configured to have a control section 101 for conducting control to solve the problems can be solved, even for a small dot, a thin line, or a thin character, such as a color-coded display not being recognized by the weak color vision person and the original color not being retained for the general color vision person, with a state suitable for observation of both a general color vision person and a weak color vision person, a storage section 103 for storing information related to color vision characteristics and textures corresponding to the color vision characteristics, or the like, an operation section 105 through which an operator inputs an instruction related to color vision characteristics information and information related to textures, a first area extraction section 110 for extracting a first area constituting a dot, a line or a character in a displayable area, a second area extraction section 120 for extracting a second area constituting a periphery of the first area, a first area color extraction section 130 for extracting the color of the first area, an intensity modulation processing section 140 for generating an intensity modulation element whose intensity has been modulated according to the color of the first area through the intensity modulation processing, and an image processing section 150 for adding the intensity modulation element in the second area or the first and second area for output when the color of the first area corresponds to a predetermined color.

The output of the information conversion apparatus 100 is carried out by displaying an image on the display device 200 or printing.

### (A2) Procedure of the Information Conversion Method, Operation of the Information Conversion Apparatus, and Processing of the Information Conversion Program

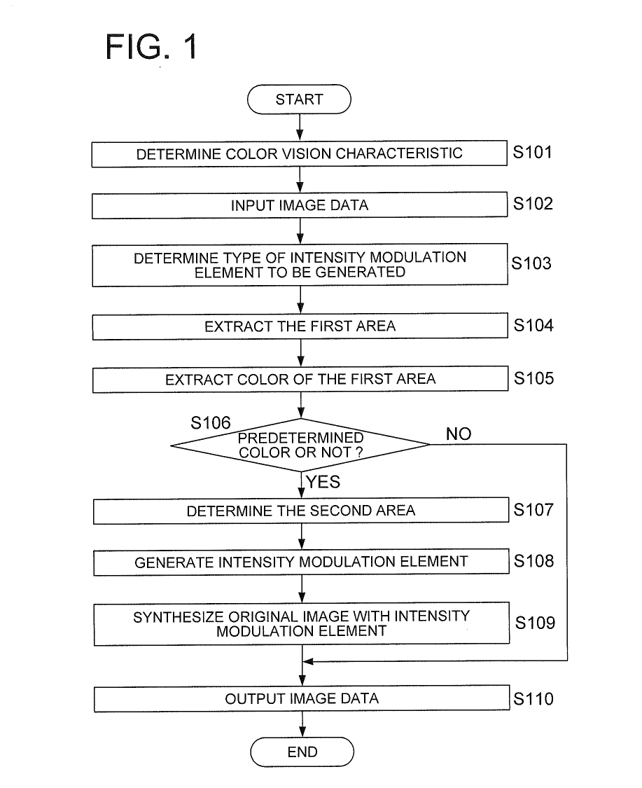

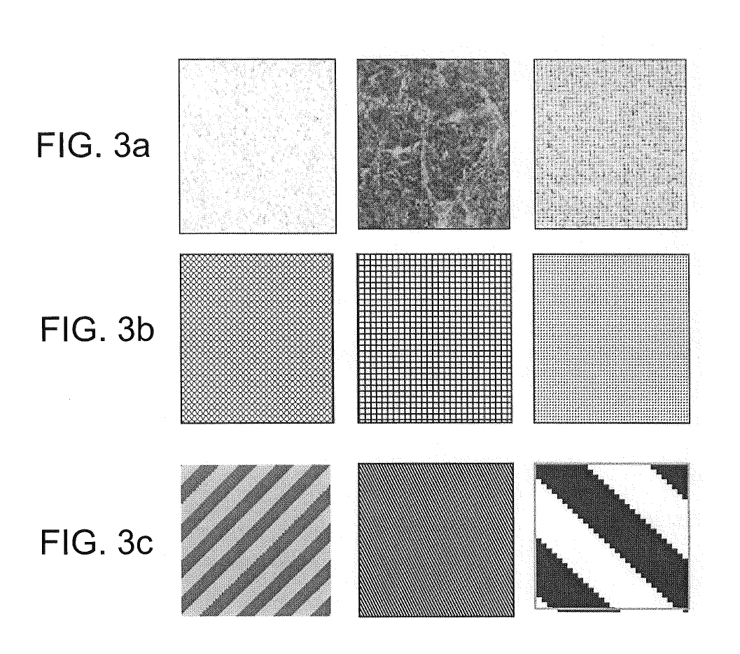

In the following, explanation of the operation of the present preferred embodiment is given referring to the flow chart of FIG. 1 and the characteristics diagrams of FIG. 3 and thereafter.

Here, FIG. 1 shows the basic processing steps of the present preferred embodiment.

(A2-1) Determining the Color Vision Characteristics:

The color vision characteristics are determined that become the target at the time of carrying out information conversion of a color image according to the present preferred embodiment (Step S101 in FIG. 1).

This color vision characteristics information is either input by the operator using the operation section 105, or is supplied from an external apparatus as the color vision characteristics information.

As this color vision characteristics information, if it is the case of a weak color vision person it can be the information as to which type the person belongs among the types, or can be the information as to which color the person finds difficulty in distinguishing. In other words, the information of color vision characteristics is the information related to the areas for which the colors are different in the chromatic image but the results of light reception at the light receiving side are similar (similar and difficult to distinguish).

The color vision characteristics of the operator viewing an image by using display device 200 can be obtained automatically from an ID card or IC tag.

(A2-2) Input of Image Data:

Next, the chromatic image data is input to the information conversion apparatus 100 (Step S102 in FIG. 1). It is also possible to provide an image memory not shown in the figure in the information conversion apparatus 100 and to store the image data temporarily.

(A2-3) Determination of Intensity Modulation Element Type:

Then, the control section 101 refers to the texture information given from the operation section 105 or an outside and determines type of the texture as the intensity modulation element to be added by information conversion of data of chromatic color image according to the present embodiment (Step S103 in FIG. 3).

This type of texture is determined by the texture information, and this texture information is either input by the operator via the operation section 105, or is supplied as texture information from an external apparatus. Or else, it is also possible for the control section 101 to determine the texture information according to the image data.

Here, a texture means the pattern in an image. For example, this means spatial variation of color or density as is shown in FIG. 3a. Here, although the expression has been made in monochrome due to the specifications of patent application drawings, in actual fact, this should be taken to mean spatial variation of color or density.

Further, this also means patterns of geometrical figures as is shown in FIG. 3b. Here, although the expression has been made in monochrome due to the specifications of patent application drawings, in actual fact, this should be taken to imply geometrical figures in color.

Further, this also means hatching in the form of grid patterns as is shown in FIG. 3c. Here, although the expression has been made in monochrome due to the specifications of patent application drawings, in actual fact, this should be taken to imply grid patterns in color. In addition, the composition of hatching need not only be binary rectangular waveforms, but can also be smooth waveforms such as a sine wave.

(A2-4) The First Area Extraction:

Now, the first area extraction section 110 extracts, as the first area, an area constituting a dot or line, or a character, in the displayable area of original image data (Step S104 in FIG. 1).

The first area is a thin area such as a character or a line, having a thickness of a predetermined value or less, including, for example, a line in a line chart and a frame of a chart or a table.

An originally hatched area or an area where hatching is unwanted can also be handled as the first area.

The predetermined value for the thin area is preferably determined as a thin value in accordance with the viewing angle since the intensity modulation will be hard to be recognized unless at least about a cycle or a half cycle of the intensity modulation is added in the area. The viewing angle can be estimated based on the size of the displayable area or the size of the surrounding characters, and the thin value can be determined by calculation from it.

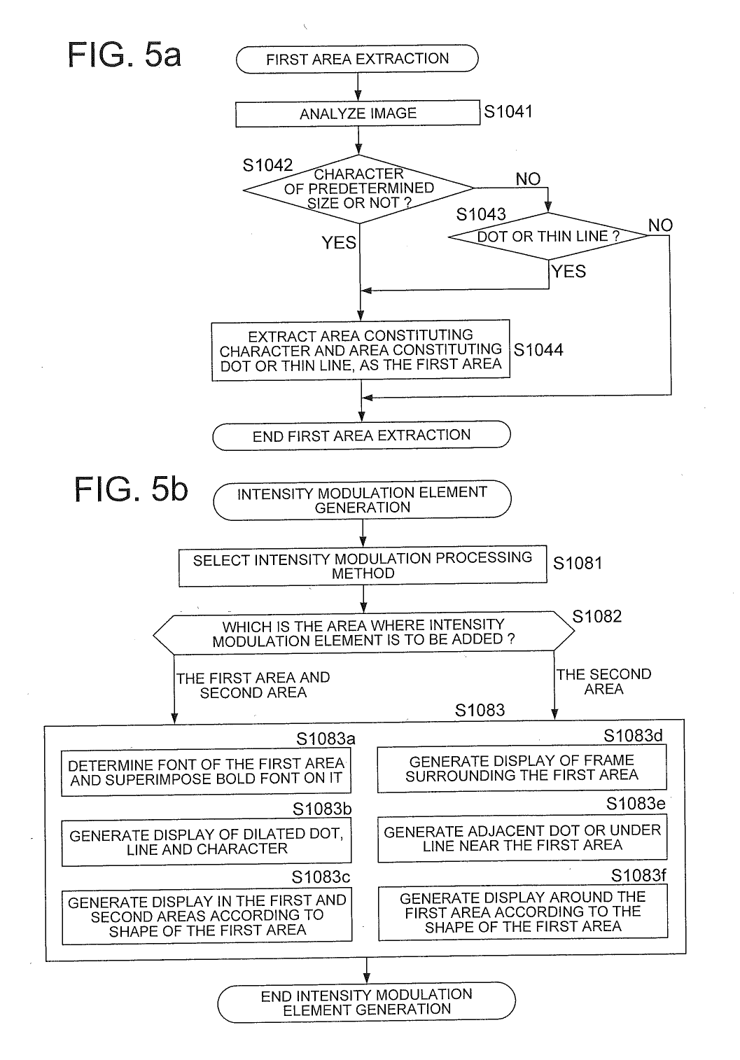

To extract the first area, the image (image data) is analyzed (Step S 1041 in FIG. 5a), and if object information (font information or line-drawing information) is available, the information is used. Whether the character has enough area (thickness) or not can be determined from the font type and size (Step S1042 in FIG. 5a). For example, when “bold” is specified as a font attribute, the character is likely to be thick, and when the font size is large, it is likely to be a thick character. A threshold value is set in advance for the absolute value of the point number or the size of the font or for the relative size of the font with respect to the displayable area to determine the above.

When such object information is not available in advance, for example, when only bit-map image data is available in color copying, a histogram is obtained for every small area, and the area ratio of a character in the area is calculated. At this time, when the ratio of the character-like area compared to the background color is small, it is determined as a thin character. This process, however, is not performed for the portion determined as a picture area after the picture area is identified by using a known picture/character discrimination method.

In the determination of the thin line or the thin character (Step S1043 in FIG. 5a), the threshold value may be changed in accordance with the wavelength of hatching. The thin line or character preferably has a thickness of at least one cycle of hatching to be recognized.

It is preferred here that the cycle of hatching be determined based on the visibility of hatching. One cycle may be preferably based on a viewing angle of approximately 0.5 degrees. The viewing angle can be presumed from the size of the displayable area or the size of the surrounding characters. Presumably, for example, characters cannot be read unless the viewing angle is 0.2 degrees or more, and an A4-sized paper is viewed within a distance of 60 cm.

On the other hand, frequency may be changed according to the thickness of the character. Ideally, hatching of two cycles to the width of the character is preferably added. When an application area is limited to, e.g., only an area to be emphasized, the application area may be selected at this area.

Then, the first area extraction section 110 extracts the area having been extracted in the above manner as the first area (Step S1044 in FIG. 5a).

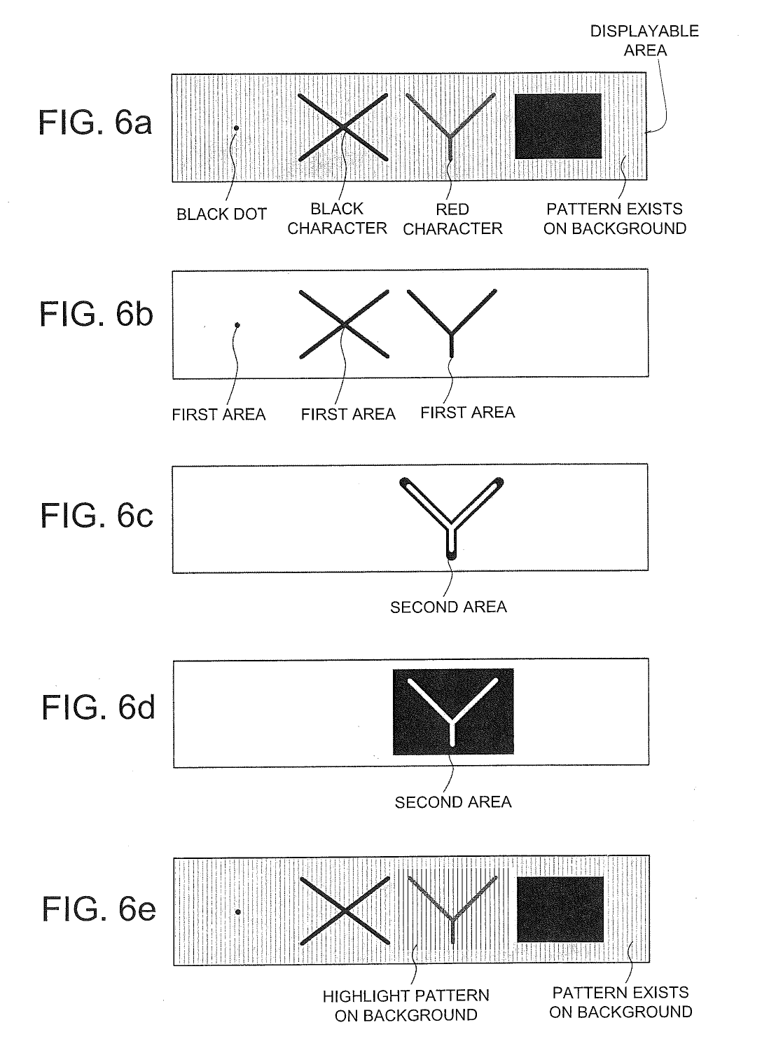

FIG. 6a shows an example of an image in which, a black dot, a black character “X”, a red character “Y”, and a black square are found as four items of a symbol, character, and figure on a patterned background.

In this case, the black dot, the black character “X”, and the red character “Y” are regarded as a dot, a line, and a thin character, respectively, and extracted as the first areas by the first area extraction section 110. The square has enough size for a weak color vision person to recognize its presence, thus it is not regarded as the first area.

(A2-5) The First Area Color Extraction:

With regard to the first area extracted by the first area extraction section 110 as above, the first area color extraction section 130 extracts a color of the first area (Step S105 in FIG. 1).

Now, the first area color extraction section 130 obtains the average color of a selected first area. When object information is available from printer output for example, the information is used. When the image is from a copier, colors are extracted by segmentation processing to calculate the average color. A commonly used method can be employed for the segmentation processing. For example, a histogram shape is checked and the valley portion is set as a threshold value. An appropriate representative value such as the middle value may be selected in place of the average color.

(A2-6) The First Area Color Determination:

With regard to the color of the first area extracted by the first area color extraction section 130 as above, whether or not the color corresponds to a color in a color vision information specified in color vision characteristic information is determined by the control section 101 or the first area color extraction section 130 (Step S106 in FIG. 1). That is, it is determined whether or not the color corresponds to a color difficult to be identified by a weak color vision person. This determination, however, with regard to the color of the first area is not essential, thus it may be performed if necessary.

Now, when the color of the first area is not a color difficult to be identified by a weak color vision person (NO in Step S106 in FIG. 1), the information conversion processing in the present embodiment is unnecessary, thus the process is finished (END in FIG. 1). On the other hand, when the color of the first area is a color difficult to be identified by a weak color vision person (YES in Step S106 in FIG. 1), the information conversion processing in the present embodiment is necessary, so the following process will be carried on.

(A2-7) The Second Area Determination:

Now, the second area determination section 120 determines the second area constituting a periphery of the first area (S107 in FIG. 1). The second area basically means the area around the first area. For example, it is an area immediately around the character or the line drawing corresponding to a predetermined number of dots.

It is preferred here that an area of at least two cycles of hatching around the part determined as the first area be selected. To select the area, one of the following methods is selected according to an instruction, if there is an instruction from the control section 105 or the outside.

(A2-7-a) When the first area is a character, an area corresponding to a predetermined number of dots around the character is determined as the second area (see FIG. 6c).

(A2-7-b) When the first area is a character, an area of a predetermined shape (a circle or a square) surrounding the entire character is determined as the second area (see FIG. 6d).

(A2-7-c) When the first area is a line-drawing such as a graph, the second area is determined based on the distance from the first area equivalent to the abovementioned area. For example, in the same manner as calculating territorial sea, an area having a predetermined distance is calculated. For practical calculation, “dilation” in image processing may be used. Technical information on this dilation processing can be found in, for example, http://www.mvision.co.jp/help/Filter Mvc Expansion.html.

The above second area may be not only the background area, but also an area slightly away from the periphery or a part of it as long as its association with the first area is clear. For example, the first area may be indicated by an arrow while the second area is in the margin.

Other than the background area, a thick underline attached to characters, or a thick line or a large dot on characters may be used as the second area.

When the first area is a character and when this character is close to the character area of another character, the second area of this character is set to the midpoint or closer to this character to avoid overlapping with the second area of the other character. Otherwise, the adjacent characters may be separately handled for calculation and respective second areas may be superimposed (combined). In this case, the image will be rather complicated.

(A2-8) Generation of Intensity Modulation Element:

Here, the intensity modulation processing section 140 generates the intensity modulation element whose intensity has been modulated according to the color of the first area when the color of the first area corresponds to a predetermined color (Step S108 in FIG. 1).

Here, as is described later, regarding the areas, such as on a color confusion line, in which the results of light reception in the light receiving side are similar and are difficult to distinguish, according to the differences in the original colors, it is desirable to select the textures from among textures having patterns or hatching with different angles, textures having patterns or hatching with different contrasts, textures that change such as blinking at different intervals, textures that move at different time periods at different speeds or in different directions, and textures that move in different directions (Step S1081 in FIG. 5b).

Further, even when the patterns are plain but they blink due to changes in the brightness, they are considered as textures in the present preferred embodiment. Further, when the image data that is input is plain, it is possible to use any of the above textures. In this case, if there is an instruction from the operation section 105 or from an external apparatus, textures are selected in accordance with that instruction. Further, if there is no instruction from the operation section 105 or from an external apparatus, the textures determined by the control section 101 are selected.

In addition, when hatching and patterns are present in the image data that is input, so as to differentiate from the existing hatching and patterns, the intensity modulation processing section 140 under instruction from the control section 101, generates textures of different types, or with different angles, or with different contrasts, or textures that change at different periods.

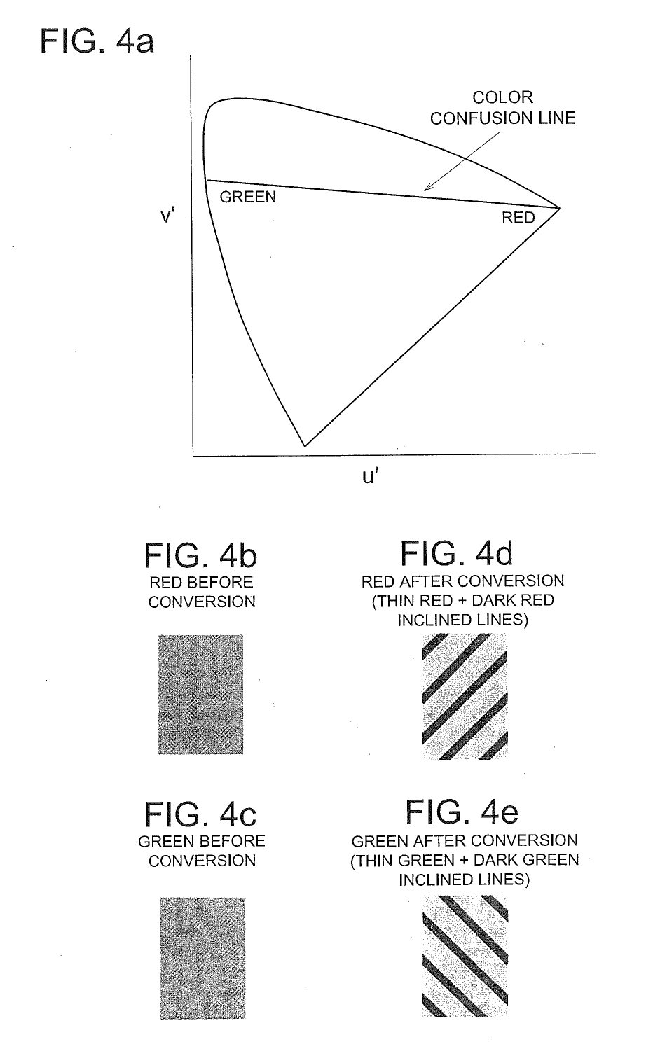

Here, it is assumed that the area in which the results of light reception on the light receiving side are similar and are difficult to distinguish is the color confusion line in the u′v′ chromaticity diagram shown in FIG. 4a, and that the condition is one in which green to red is being found difficult to distinguish. In this case, red before addition processing of the intensity modulation element (FIG. 4b) and the green before addition processing of the intensity modulation element (FIG. 4c) are in a condition in which it is difficult to distinguish between when viewed by a person with weak color vision. In view of this, for example, in the case where hatching is selected as a texture, regarding the end part on the red side on the color confusion line, a hatching with an angle of 45 degrees is generated as the texture (FIG. 4d). Further, regarding the end part on the green side of the color confusion line, a hatching with an angle of 135 degrees is generated as the texture (FIG. 4e). Further, at positions in between the two end parts, hatching with continuously changing angles according to that position is generated.

Because of this, the condition is appropriate for viewing by a weak color vision person, and also, distinguishing is possible because the view is close to the original view equivalent to the viewing by a general color vision person.

Further, it is also desirable that the textures, according to the differences in the colors in the original image data, have different contrasts in the pattern or hatching of the texture. In this case, it is possible to make the contrast strong at one end on the color confusion line and the contrast weak at the other end, and to change the contrast continuously in between. In addition, it is also available to make the contrast weak at the middle and strong at both the ends.

Further, apart from the angle or contrast of the pattern or hatching, it is possible to make the density of hatching (spatial frequency) dense at one end on the color confusion line and to make it sparse at the other end, and to change the density continuously. Even for this, it is possible to think of various methods for the setting of the denseness or sparseness of the frequency in a similar manner.

In addition, instead of the angle of the pattern or hatching, as the duty ratio of the pattern or hatching, it is also possible to change continuously the thickness of the hatching line according to the position on the color confusion line. Also, it is also possible to change the duty ratio according to the brightness of the color to be expressed.

Furthermore, this texture can also be made a combination of two or more from among pattern or hatching with different angles according to the difference between the colors in the original image data, with different contrasts according to the difference between the colors in the original image data, changing with time or moving at different speeds according to the difference between the colors in the original image data, and moving in different directions and with different speeds according to the difference between the original colors. In addition, even in this case, it is also possible to make the state differ continuously according to the difference between the colors in the original image data. In this case, by changing the plural combinations, it is possible to express the position on the color confusion line freely.

Further, when not printing out but displaying in a display or the like, instead of the angle of hatching, the speed of movement or direction of movement of hatching is used. By making the hatching stop at the middle position on the color confusion line, making the speed of movement faster as it becomes closer to one end, and by making the hatching move in the opposite direction with increasing speed as it becomes closer to the other end, it is possible to make continuous changes according to the position on the color confusion line. In addition, even when other textures are used, it is possible to express the position on the color confusion line by the angle of that texture, duty ratio, speed of movement, blinking frequency, and others.

In other words, an intensity modulation element suitable for the area to which the intensity modulation element is added, is generated (Steps S1082 and S1083 in FIG. 5b)

For example, in the case of the original image of FIG. 6a, since the character “Y” is a character having a color which a weak color vision person has difficulty to recognize, an intensity modulation element by means of a texture such as hatching is generated in the second area (FIG. 6c or 6d) extracted as described above (FIG. 6e). In this case, it is sufficient that the contrast is intensified by using an originally existing pattern of background.

(A2-9) Synthesizing Original Image Data and Intensity Modulation Element:

Next, in the image processing section 150, the textures that are generated in the intensity modulation processing section 140 as mentioned above and the original image are synthesized (Step S109 in FIG. 1). Further, at this time, before and after adding the textures, it is desirable that no change occurs in the average color or average density of the image. For example, in the condition in which the textures have been added, darker colored hatchings are added in the base part of a lighter color than the color of the original image. In this manner, it is desirable that the observation by a general color vision person is not affected and the original view is retained by not changing the average color in the region in which a texture has been added from the original color, or by making it resemble the original color.

Now, after the first and the second areas are determined, these areas are superimposed with an intensity modulation element (hatching, texture, blinking, and others)

Some patterns for performing this are as follows.

(A-2-9-1) The original color remains in the first area, and the second area (the background color) is shown in hatching contrast intensity in accordance with the original color of the first area. At this time, the average color of the second area is the same as before, and the hatching angle of the background color is unchanged.

(A-2-9-2) The first area is the same as above and the second area is shown in the intensity of the original color, and the hatching angle is in accordance with the character color.

There are above patterns and others.

Since the chromaticity is shown by contrast intensity in the above (A-2-9-1), it is difficult for a weak color vision person to accurately identify the character color, however, in the above (A-2-9-2), the angle information is given so that the character color can be accurately identified. A method for changing the average color of the second area will be described in the second embodiment to be described later.

The hatching contrast intensity in the intensity modulation element is varied according to chromaticity and chroma. When the area has a high chroma, the hatching contrast intensity is increased. In addition, the contrast intensity may be increased by a highlight color such as red. On the other hand, when a black character is on the white background, either no process is performed or a degree of the hatching contrast intensity is decreased. A process for when a color character or a color line-drawing is on the white background will be described in the second embodiment to be described later.

A hatching parameter of the intensity modulation element may be changed as follows.

(A-2-9-3) Texture or hatching frequency (fineness) may be common to the first and the second areas, or it may be changed in accordance with the thickness of the first area. For example, the frequency is set to twice the thickness of the first area (a half wavelength).

(A-2-9-4) When two colors are closely positioned and the respective second areas are close to each other, only the first areas may be hatched.

The above area where hatching is added as an intensity modulation element may be superimposed with a texture in place of hatching, or may be shown in a blinking color or light. The second area may be blinked to represent its chromaticity by the cycles or contrast of the blinking.

In addition, when the first area is a character, the character may be made thicker by a character-thickening image processing or by changing the character to a larger size, bold, or popish font, to make hatching on the character visible, and therefore, these processes may be further added.

The hatching created may be kept as a separate layer, and a user may be allowed to decide about the use of the hatching.

(A2-10) Outputting Converted Image:

The image after conversion by adding textures to the original image in this manner in the image processing section 150 is output to an external apparatus such as a display device or an image forming apparatus (Step S110 in FIG. 1).

Further, the information conversion apparatus 100 according to the present preferred embodiment can exist independently, or can also be incorporated inside an existing image processing apparatus, an image display apparatus, or in an image outputting apparatus. Further, when incorporated inside another apparatus, this can also be configured to be used commonly with the image processing section or the control section of the other apparatus.

### (A3) A Modification Example of the Entire First Embodiment

An application area may be selected partially within the image data. A separate intensity modulation method (a hatching policy) may be applied to each of plural areas.

The method may be applied to only an area to be noticeable to a weak color vision person. Noticeability may be individually specified by an operator based on a result of weak color vision simulation as shown in the figure.

Noticeability may be determined by obtaining a histogram of the entire or a partial color of the image data, and when a small amount of color contained in there is significantly different from the other, the color may be determined as noticeable.

When the second area cannot have an enough area, the result will be difficult to see, thus a set of logic to delete the process may be included.

### (A4) Effects Obtained by the First Embodiment

As described above, while hatching added on a thin character has a poor visibility and therefore makes chromaticity identification difficult, the chromaticity of the character can be represented by the intensity modulation element such as hatching in the second area such as the background or the surrounding, allowing the chromaticity of the character to be recognized. Furthermore, a problem such as the character being unnoticeable by its color can be solved by, for example, as shown in FIG. 6e, emphasizing the background hatching to show the difference between the character and the others.

In addition, even when the area is thin, information of the area, about what is the color can be shown by a texture or hatching to communicate the color information to a weak color vision person.

When the width of the area is narrow, its background is textured or hatched, and when the width is wide, the area itself is textured or hatched, so that addition of the information is not limited to the background only, leaving the document uncluttered.

Information of the original character or line is shown in the surrounding so that data association is easily recognized. Furthermore, a subtle difference in colors can be indicated by hatching inclination or contrast, and an absolute determination standard can be communicated by using the inclination.

The information conversion apparatus is configured to process the information conversion so that the information conversion process can be performed quickly to output a processed image.

That is, intensity modulation in accordance with the color of the first area is added to the second area, or the intensity modulation in accordance with the color of the first area is added to the first and the second areas to create a state suitable for both a general color vision person and a weak color vision person so that problems can be solved, such as a color-code display not being recognized by the weak color vision person and the original color not being retained for the general color vision person.

### (B) The Second Embodiment

The second embodiment will be described below. Description of the common parts with the first embodiment above will not be repeated here, but description will be focused on the distinctive features of the second embodiment, which are different from the first embodiment.

### (B1) Configuration of the Information Conversion Apparatus

The information conversion apparatus 100 used in the second embodiment is identical to the information conversion apparatus 100 shown in FIG. 2 above, thus the description will not be repeated.

### (B2) Procedures of the Information Conversion Method, Operation of the Information Conversion Apparatus, and Process of the Information Conversion Program

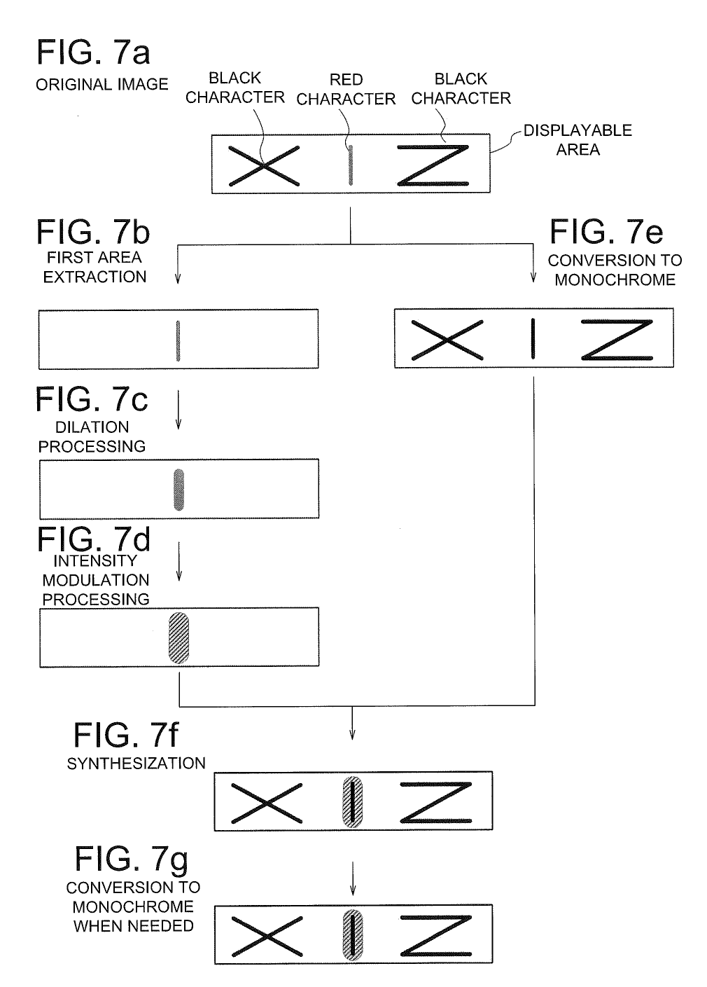

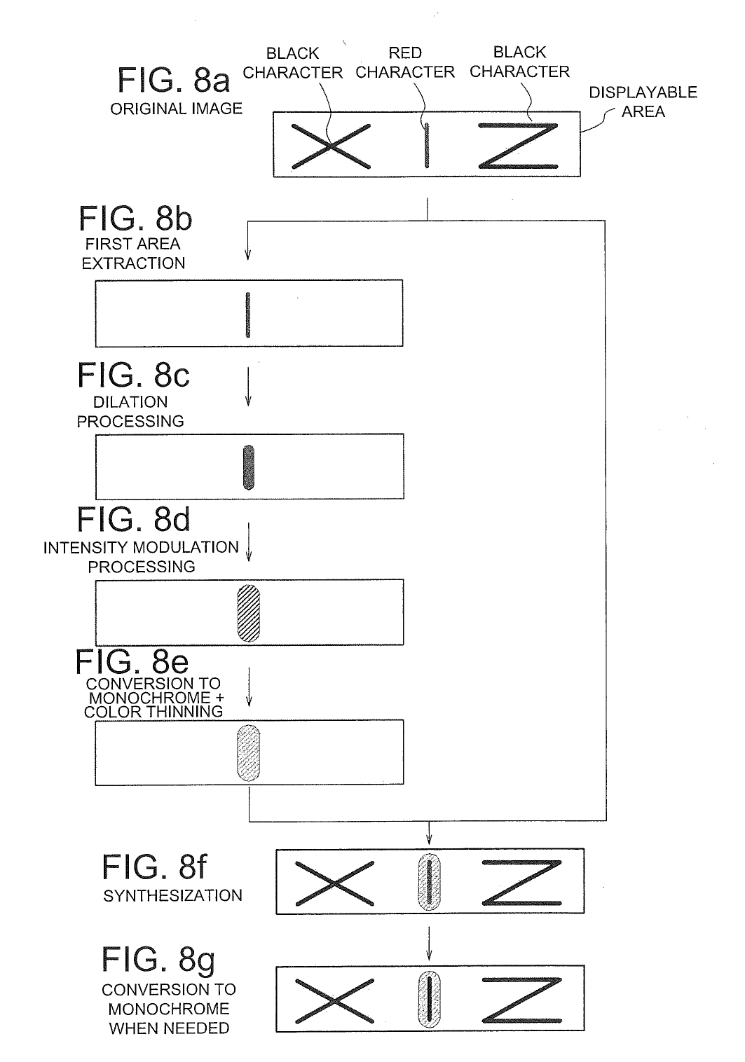

Operations in the second embodiment will be described below using FIGS. 7 and 8, focusing on a difference from the first embodiment.

(B2-1) Generation of the Second Area:

A method suitable when a character or a line-drawing is on a white background, unlike the first embodiment, will be described here.

The difference from the first embodiment is that the second embodiment has a process in which the second area is newly created from the character or the line-drawing. There are two ways for this process, which will be described based on FIGS. 7 and 8.

(B-2-1-1) Extraction of a Character or a Line-Drawing:

When object information of a character or a line in image data is available from a printer, or the like, the character or the line is extracted based on the object information. When such object information is not available but only image information from copying is available, a thin line portion is extracted by image processing in the same manner as in the first embodiment.

(B-2-1-1a) Monochrome Conversion of the Character Portion, and Increase in Contrast with the Background:

A chromaticity component is removed from the character (FIG. 7e). This can be achieved by calculating a brightness component Y contained in each RGB color component, based on Y=0.1B+0.6G+0.3R. If necessary, the contrast may be further increased.

(B-2-1-2) Dilation Processing of the Color Character Portion:

Using “dilation” in image processing, a line portion constituting the character, extracted as the first area (FIGS. 7b and 8b), is dilated (FIGS. 7c and 8c). The thickness is determined in accordance with its chroma, that is, it is determined in accordance with a distance from the achromatic color to the value of the color of the character calculated in the u′v′ chromaticity chart. A character or a line-drawing with high chroma is made thicker while a character or a line-drawing with no chroma is left as it is. This leaves a monochrome character unchanged in the original state. The thickness can be increased stage by stage or changed to a fixed value. Because of this, the noticeability of the character recognized by a weak color vision person will be similar to that for a general color vision person.

It is preferred that the area for intensity modulation retain the color or chromaticity of the second or first area, or the average thereof.

(B-2-1-3) Superimposition of Hatching in Accordance with the Chromaticity:

A texture among various textures (hatching, patterns, or blinking), using an inclination or contrast in accordance with the chromaticity of the area, is superimposed (FIGS. 7d and 8d), which will be discussed in the third embodiment described later.

(B-2-1-3a) Conversion to Monochrome:

A chromaticity component is removed here (FIG. 8e). This can be calculated as Y=0.1B+0.6G+0.3R.

(B-2-1-3b) Reduction of the Contrast with the Background:

The contrast is reduced so as to make the second area not too deep (FIG. 8e). This contrast is preferably about a 10% to 50% contrast so that the character portion is deep enough to be seen and can be emphasized in some degree when it is synthesized later.

(B-2-1-4) Synthesization of the Character and the Background Portions:

The image data processed as above are synthesized (FIGS. 7f and 8f). To synthesize the data, they may be added and divided by two, or the character portion data may be preferentially selected before the synthesization.

At this point, in FIG. 7, the red character, which is difficult to be recognized by a weak color vision person, has been converted to a black character, and the original color of the character is in the background. This allows a general color vision person to see the original color and a weak color vision person to know the color type by hatching. In addition, since the line is dilated, it is emphasized in accordance with the chroma of the area.

On the other hand, in FIG. 8, while the original colors of all characters are left as they are, the red character, which is difficult to be recognized by a weak color vision person, has light hatching in the background. This will create the same effect as in FIG. 7. In the case of FIG. 8, there is no conversion in a character color. In the other words, a red character remains as red so that a general color vision person will have less feeling of strangeness.

In FIG. 8, converting all the characters into monochrome may reduce the contrast between the thin line portion and the dilated or the background portion, making the character difficult to be seen; thus the contrast may be increased in advance. In anticipation of monochrome conversion, the chroma of the thin line portion may be adjusted so that the chromaticity of the line is unchanged for a general color vision person to have less feeling of strangeness, and further the characters are easier to see when converted into monochrome. The line may be converted into monochrome in advance to make the character even easier to see after monochrome conversion. The data converted into monochrome in advance may be kept in a separate layer.

(B-2-1-5) Monochrome Conversion:

When this method is applied to a monochrome display such as in monochrome printing for example, the data is directly converted into monochrome. The chromaticity of the original can be understood from hatching and the original color can be understood from hatching inclination after monochrome conversion, and then a monochrome character image is achieved in which a character is emphasized by dilation or hatching.

When color image data is directly sent to a monochrome printer, a print result may be blurry, and therefore, this process is preferably performed when color image data is to be printed on a monochrome printer.

### (B3) A Modification Example of the Second Embodiment

When a character includes various colors, hatching is varied according to sections. In order to determine the sections, segmentation is preferably performed based on the color names.

### (B4) An Application Example of the Second Embodiment

When the original image or the original document had been emphasized with a color standing out for a general color vision person but was difficult to see for a weak color vision person (such as red or green), and the image or the document has been modulated or converted into monochrome by the above method, it is preferred that a note about the conversion be added in a color that stands out for a general color vision person but is difficult to see for a weak color vision person. In this way, a general color vision person will be informed that the converted display is barrier-free, and complaints with regard to the display can be avoided.

To be more specific, the following methods may be used. That is, a note is added somewhere in the document in a color that stands out for a general color vision person but is difficult to see for a weak color vision person, notifying that the above conversion process has been applied, or a predetermined mark or a symbol is displayed in the vicinity of converted characters. Dots or a wavy line may be added alongside of the converted characters to avoid interfering the display.

For example, as in FIGS. 7 and 8, when areas around characters are dilated as the second areas to be displayed in hatching, or the like, all the characters may be enclosed by a dashed line or underlined in a color that is difficult to see for a weak color vision person, to inform a general color vision person that the information conversion process for a weak color vision person has been applied. This can prevent a complaint that the display has ink bleeding. In the same manner, a display such as “This mark indicates a display made easier for a weak color vision person to view” may be printed somewhere on the paper in red.

### (B5) Effects Obtained by the Second Embodiment

Even when a color character is on the white background, the second embodiment allows the original color to be retained, the color to be distinguishable, the noticeability to be retained (in a similar way viewed by a general color vision person), and the chromaticity of the character to be recognized by a weak color vision person.

When a thin character or a line-drawing is displayed in monochrome, color information of the character or the line can be added and displayed.

In addition, even when the area is thin, information of the area indicating what is the color can be shown by a texture or hatching to communicate the color information to a weak color vision person.

When the width of the area is narrow, its background is textured or hatched, and when the width is wide, the area itself is textured or hatched, so that addition of the information is not limited to the background only, leaving the document uncluttered.

The information of the original character or line is shown in the surrounding so that the association is easily recognized. Furthermore, a subtle difference in colors can be indicated by hatching angle or contrast, and an absolute determination standard can be communicated by using the angle.

The information conversion apparatus can be configured to process the information conversion so that the information conversion processing can be performed quickly to output a processed image.

That is, also in the second embodiment, by adding intensity modulation in accordance with the color of the first area to the second area, or by adding the intensity modulation in accordance with the color of the first area to the first and the second areas, problems can be solved, such as a color-coded display not being recognized by the weak color vision person, and the original color not being retained for the general color vision person, in a condition suitable for both a general color vision person and a weak color vision person.

### (C) Third Embodiment

### (C1) Details of the Image Processing

The image processing method, apparatus, and program in the first and the second embodiments have been described above in series, and now, the details of parameter determination with regard to hatching as an intensity modulation element in the above process will be described below as a third embodiment.

In the description below, texture and hatching are used as specific examples for describing an intensity modulation element. In addition, the description below is an example specifically for a weak color vision person.

In the preferred embodiment described above, regarding areas such as on the color confusion line in which the results of light reception at the light receiving side are similar and difficult to distinguish, it is possible to recognize similar to the observation by a general color vision person by retaining the original view in a condition suitable for observation by a weak color vision person by adding textures, according to the difference in the original colors, such as textures including patterns or hatching with different angles, textures having patterns or hatching with different contrasts, textures that change such as blinking at different periods, textures that move with different periods or speeds or in different directions, textures that move with different speeds and in different directions, or textures that are combinations of a plurality of these.

Here, the parameters of the type of texture are what type of pattern, hatching, angle, or contrast the texture has.

Further, the period of blinking of the texture, the duty ratio of blinking, the speed and direction of movement, or the like, constitute the temporal parameters of the texture. It is possible to determine these parameters in the following manner.

(C1-1) Relative Position:

The temporal parameters (period, speed, or the like) at the time of changing the texture of the image or/and the parameters of the type of texture are determined to correspond to the relative position of the color of the object on the color confusion line.

Although the position naturally differs depending on the coordinate system such as RGB, or XYZ, the position can also be, for example, the position on the u′v′ chromaticity diagram. The relative position is the position that is expressed as a ratio with respect to the overall length of the line.

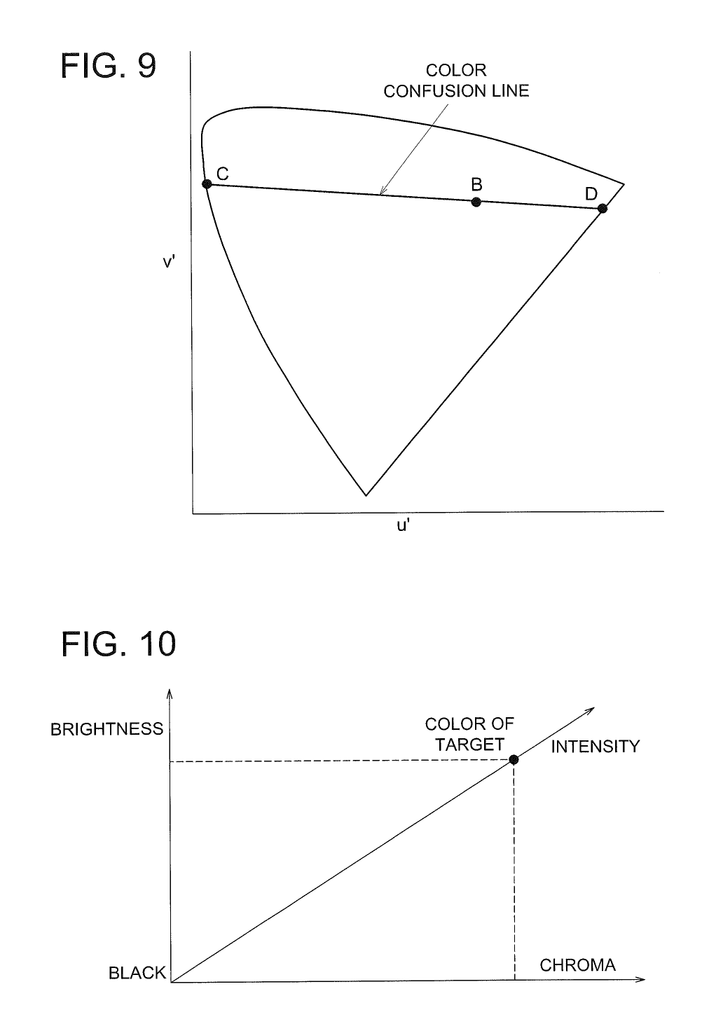

When the color of the object to be converted is taken as the point B in the u′v′ chromaticity diagram, the left end of the two points of intersection of the color confusion line passing through point B and the color gamut boundaries is taken as point C and the right end is taken as point D, the relative position P_b of point B can be expressed, for example, by the following equation (3-1-1). If a diagram is drawn, for example, that will have the positional relationships in the u′v′ chromaticity diagram such as that shown in FIG. 9.

P_{—}b=BD/CD (3-1-1)

As a method of actually expressing the position, it is also possible to express the position by increasing the reference points further apart from points C and D. For example, the point of achromaticity or the points of intersection with black body locus, point of simulation of weak color vision, or the like, can be added as a new reference point, that is, point E, and the relative position of the point B can be taken on the line segment CE or the line segment ED.

(C1-2) Parameter Change According to the Position:

Changing the temporal parameters (period, speed, or the like) at the time of changing the texture of the image or/and changing the parameter of the type of texture according to the position is obtaining, using the conversion function or the conversion table, from the position information such as the value of the equation (3-1-1), a part of the temporal information (period, speed, or the like) at the time of changing the texture of the image or/and the parameter of the type of texture. It is also possible to vary two or more parameters, and it is possible to increase the discrimination effect by making the apparent change large.

(C1-3) Continuity:

Although the above parameters can be continuous or non-continuous, it is desirable that they are continuous. When the change is continuous, in a condition suitable for observation by weak color vision persons, distinguishing becomes possible close to the original view equivalent to the observation by general color vision persons, colors can be grasped accurately, and even fine differences in the colors can be understood. However, in the case of digital processing, it will not be completely continuous.

(C1-4) Taking Ease of Distinguishing Close to that of General Color Vision Persons:

It is desirable to make the effect of ease of distinguishing by weak color vision persons as a result of parameter change correspond with the effect of ease of distinguishing by general color vision persons for the original colors. By making the ease of distinguishing resemble each other, the reading out of the display becomes closer to that of a general color vision person. If the parameter change corresponding to the position is made a continuous change, the person observing can observe the fine changes in the color as changes in the parameters, and the ease of distinguishing becomes closer to that of a general color vision person. The color differences can be taken as a reference for the ease of distinguishing by a general color vision person for the original colors. For example, since FIG. 9 uses a uniform color space, it is sufficient to make the parameters change so that the ease of distinguishing by a weak color vision person changes in correspondence with the relative position on the color confusion line of FIG. 9.

(C1-5) Contrast of Textures:

Here, the contrast of textures is described using a concrete example of parameter change. There is the method of changing the contrast of hatching as a concrete parameter change of the temporal information (period, speed, or the like) at the time of changing the texture of an image or/and concrete parameter change of the type of texture. In this case, for example, the contrast Cont_b of the color of point B is obtained using Equation (3-5-1). This is the method of interpolating the contrast of the line segment CD taking the contrast Cont_c of point C and the contrast Cont_d of the point D as the reference, and determining the contrast Cont_b according to the position of point B. Using this method, it is possible to assign a continuous parameter.

Equation 1:

Cont_{—}b=Cont_{—}c*BD/CD+Cont_{—}d*(1−BD/CD) (3-5-1)

For the unit of this contrast, it is desirable to use the color intensity difference. The color intensity is the length from the black point which is the origin to the target color, and is as shown in FIG. 10. For example, although the color of RGB=(1.0, 0.0, 0.0) and the color of RGB=(0.5, 0.0, 0.0) are both red with equal chromaticity, the color intensity of one is twice the color intensity of the other.

It is also possible to use a unit system in which the maximum value of the intensity differs depending on the chromaticity. For example, each of the three colors of the color of RGB=(1.0, 0.0, 0.0), the color of RGB=(0.0, 1.0, 0.0), and the color of RGB=(0.0, 0.0, 1.0) has their maximum brightness, but it is also possible that their intensity values are different so that their brightness is different. On the contrary, for all chromaticities, it is also possible to normalize so that the intensity becomes 1.0 at the condition of maximum brightness. It is desirable to make the intensity and brightness become equal in the achromatic condition.

In concrete terms, the intensity P can be expressed by Equation (3-5-2) or by Equation (3-5-3).

$$\begin{matrix}Equation 2 \text{:} & \\ P ( R , G , B ) = \sqrt{\frac{a {R}^{2} + b {G}^{2} + c {B}^{2}}{a + b + c}} & ( 3 \text{-} 5 \text{-} 2 ) \\ Equation 3 \text{:} & \\ P ( R , G , B ) = Max ( R , G , B ) & ( 3 \text{-} 5 \text{-} 3 )\end{matrix}$$

Here, Equation (3-5-2) is an equation of intensity in which the maximum intensities of R, B, respectively can be changed by changing the ratios of the coefficients a, b, and c. Equation (3-5-3) is an equation of intensity in which the intensities have been normalized to be 1.0 at the maximum brightness.

(C1-6) Change of Temporal Parameters:

Here, concrete examples of parameter changes of temporal parameters are described.

Although changing the period of blinking is a concrete example of the parameter change of temporal parameters (period, speed, or the like) at the time of changing the texture of an image, this does not easily contribute to the ease of distinguishing.

It is desirable that changes in temporal parameters are combined with changes in the texture. As in an electric sign board, by changing the characters with time and also changing the patterns with time, they become parameters that have effect on the ease of distinguishing. If the direction of flow of the pattern is taken as a parameter, the distinguishing becomes still easier. An effect similar to the parameter “angle of segmenting a region” to be described later will also be obtained.

(C1-7) Retention of Average Color:

As has already been described, the average of all the colors displayed when the temporal parameters (period, speed, or the like) at the time of changing the texture of the image or/and the type of texture are changed, is made roughly equal to the color of the image before conversion. For this averaging, although the method of simply adding up all the colors and dividing by the number of colors is simple, it is desirable to use an average for which the area is considered, or an average for which the display duration is considered, or the like.

‘Adding up’ is that of light synthesis by additive mixing of colors either when the present preferred embodiment is applied to light emission displays such as display monitors or electrical sign boards, or when applied to printed matter such as paper, painted sign boards, or the like.

‘Roughly equal to’ can mean either having a color difference of 12 or less of the reference value which is taken as the same color system in JIS (JISZ8729-(1980)), or can be within a color difference of 20 or less of the reference value which is the management of color name levels given in page 290 of the New Color Science Handbook, 2nd edition.

For example, in the case of the method of hatching with two colors, if the areas of the two colors are equal, then it is sufficient to take a simple average of the two colors. If the color of the object is violet., if the hatching is of red and blue colors, then the average will be the violet color.

(C1-8) Retention of Chromaticity:

As has already been described, the chromaticity of all the colors displayed when the temporal information (period, speed, or the like) at the time of changing the texture of the image or/and the type of texture are changed, is made roughly equal to the chromaticity of the object before conversion. Although it is possible to change the chromaticity of the texture pattern, in this case, it becomes difficult to realize that it is a hatching because of the color vision characteristics of humans. This is because, in the color vision characteristics of humans, changes in darkness and brightness are more easily recognized than changes in the chromaticity. By unifying the chromaticity, it is possible to observe that it is a part constituting the same object, and also there is less feeling of strangeness. It is possible to convey without mistakes the chromaticity that leads to the judgment of color names.

In concrete terms, in the case of the method of hatching, since it is a change in the type of texture constituted by two straight lines (or areas of different colors), it is sufficient to make the respective chromaticities of the two lines roughly equal to each other, and to change only the intensities. Because of this, it is possible to share text with persons having general color vision, and it is possible to obtain the effect that there is no mistaking of the chromaticity, there is small feeling of strangeness, and there is small reduction in the effect of distinguishing at high frequencies.

(C1-9) Adjustment of Spatial Frequency:

Here, concrete examples of parameter change regarding the adjustment of spatial frequency are described.

The spatial frequency of the pattern of the texture used is changed according to the size of the image figure. In other words, the frequency is set according to the size of the image to which the texture is applied and according to the size of the text characters contained in the image.

For example, if the spatial frequency of the pattern is low and it is not possible to recognize the periodicity within the image, the person viewing cannot recognize a pattern as a pattern, but may recognize it as a separate image. On the other hand, if the spatial frequency of the pattern viewed by the observer is high, it may not be possible to recognize the presence or absence of the pattern. In particular, as the distance from the observer to the display increases, the frequency viewed by the observer becomes high, and it becomes difficult to recognize the presence or absence of the pattern.

Therefore, in concrete terms, the lower limit of the frequency is set according to the overall size of the object, the upper limit of the frequency is set according to the overall text character size, and any frequency within those lower and upper limits are used.

Because of this, since the frequency is higher than the lower limit, the periodicity of the pattern in the object can be recognized, and since it becomes clear that the pattern is really a pattern, the pattern is not mistakenly recognized as an object. In addition, since often the observer views the display from a position at which the text characters can be read, there is the effect that the presence or absence of pattern can be recognized if the frequency is up to a high frequency of the same level as the text character size.

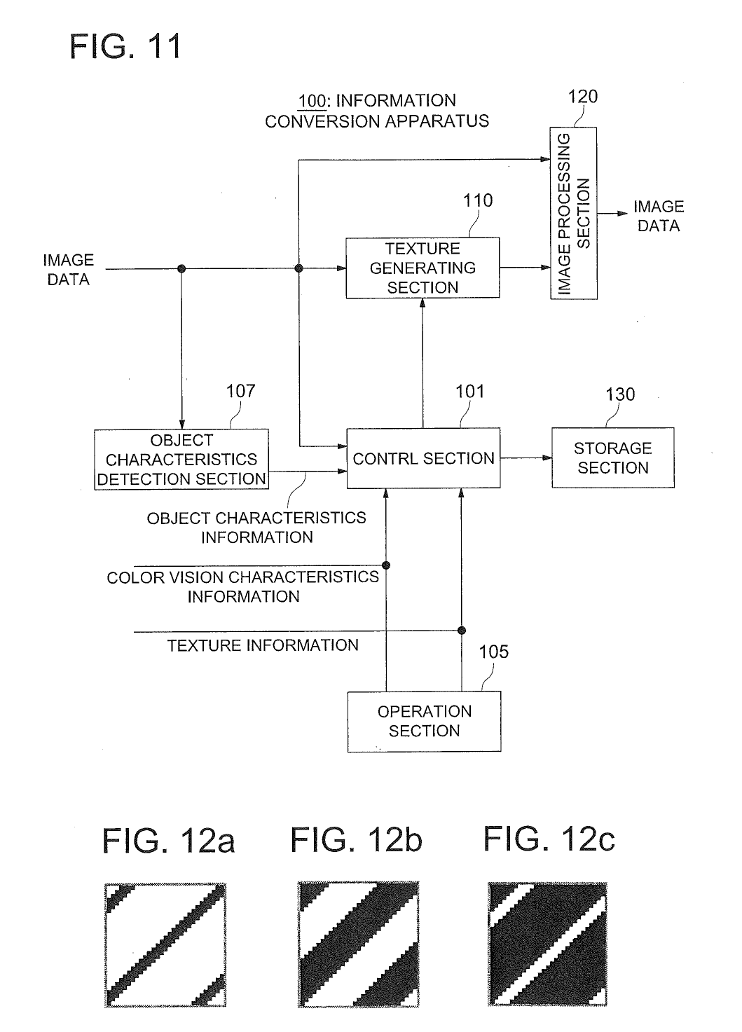

In this case, as is shown in FIG. 11, the object characteristics detection section 107 extracts the spatial frequency of a pattern, the character size, the size of figure objects, or the like, contained in the image as the object characteristics information, and conveys them to the control section 101. Next, the control section 101 determines the spatial frequency of the texture according to the object characteristics.

(C1-9-1) Method of Determining the Spatial Frequency:

Further, the following is the method of determining the spatial frequency.

### (C1-9-1-1) Basic Thinking

The frequency of the object is avoided and the frequency is made higher or lower than that frequency. This is done in order to avoid confusion between the object and the hatching, and to cause the recognition of the presence or absence of hatching.

Further, the presence or absence of hatching cannot be recognized if the frequency is too high, and if the frequency is too low, there is the likelihood of confusion between the object and hatching.

### (C1-9-1-2) In the Case of Characters

When a person reads characters, that person adjusts the distance according to the size of the characters. From experiments it was found that people often view at a distance so that the size of the characters is about 0.2 degrees. Considering the spatial resolution of the eye and the spatial frequency of the structure of the character itself, it was found that a frequency of less than three times the frequency of the character size is desirable. When the frequency is higher than this, there will be interference with the characters making them difficult to view, and it may not be possible to recognize as hatching visually.

### (C1-9-1-3) In the Case of Graphic Objects

In the case of circular or rectangular objects, a frequency of more than twice or less than half is desirable. This is for avoiding confusion between graphic objects and hatching.

### (C1-9-1-4) Modified Example

Further, as a modified example, in case there are characters and objects with different sizes, it is desirable to follow the above standard according to the sizes of nearby characters and objects, and to determine the nearby frequency in an adaptive manner.

(C1-10) Duty Ratio of Hatching or Patterns:

Here, concrete examples of parameter changes are described regarding the duty ratios of hatching or patterns.

When the average color is a color near the color gamut boundary, in order to solve the problem that the contrast cannot be made high, the duty ratio of hatching of pattern is changed appropriately.

Although a constant value is normally used for the duty ratio in hatching, when hatching an object whose color is near the color gamut boundary, if the color intensity difference is made higher than a certain value without changing the average color, sometimes a part of the color may cross the color gamut boundary. Because of this, it may not be possible to realize hatching with the above parameter.

In the above case, it is sufficient to increase appropriately the display of the color near the color gamut boundary while setting the contrast so that it does not cross the color gamut boundary. In the case of hatching, as is shown in FIGS. 12a, 12b, and 12c, it is sufficient to adjust the duty ratio appropriately. In the case of a wider spatial change, it is sufficient to increase the display using the area ratio, and to increase the display time if it is a temporal change. Because of this, it is possible to acquire color intensity difference without changing the average color.

For example, when generating hatching in black and white, near black, it is possible to set so that the area ratio is such that black>white.

(C1-11) Contour Line:

Contour lines are provided at the locations where hatching is used. By doing this, confusion between hatching and object is avoided. This can be used not only for hatching but also for other textures.

When using hatching, when the color of a neighboring object and the color of a part of hatching become roughly equal, depending on the shape of the neighboring image, it is possible that there is confusion between the two objects. In concrete terms, the slant lines constituting hatching are confused with the neighboring lines of the same color.

In the above case, contour lines are provided to the image for which hatching is used as the texture. It is desirable that the contour line is of the average color of the texture.

By doing this, the shape of the image becomes clear due to the contour line, and also, by making it of the average color, since the two colors of the slant lines of hatching and the contour line are different, it becomes difficult to confuse the image to which hatching is added and its neighboring image.

(C1-12) Angle of the Texture:

Here, concrete examples of parameter change are described regarding the angle of the textures.

One of the parameters is taken as the angle of segmenting the region. By doing this, while it becomes easy to distinguish, in addition, in the case of angles, since the observer has an absolute reference, the chromaticity can be judged more accurately. If the correspondence between angle and chromaticity is determined in advance, it is easy to memorize the legend.

By changing the temporal parameters (period, speed, or the like) at the time of changing the texture of a general image or/and the type of texture, since there is no standard for absolute judgment, it is difficult to read out said parameters. Since they are also difficult to keep in memory, it is difficult to establish correspondence between said parameters and the color without referring to the legend. It is better to express said parameters using a method by which it is easy to view as changes in shape, and an absolute judgment standard can be possessed.

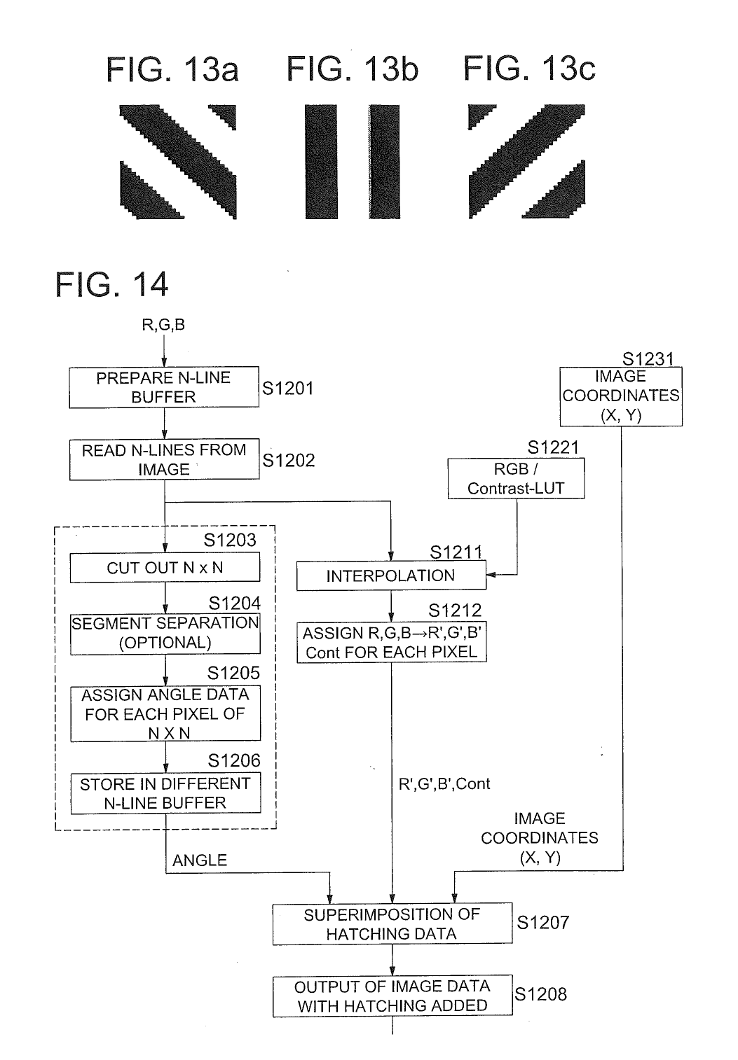

Because of this, the angle of region segmentation is used as a parameter. In the case of the method of region segmentation, the parameter of the angle can be viewed easily as a change in the shape, and can be judged absolutely. Specifically in the case of hatching, the angle Ang of point B under the conditions shown in FIG. 9 is determined by the following Equation (3-12-1). If the point B is taken as the center of the line CD, the angle Ang of the points BCD can be like any one of FIGS. 13a, 13b, and 13c.

Ang=90×(BD/CD)+45 (3-12-1)

Further, by making this angle change in the chromaticity diagram, it is possible to establish correspondence to some extent between the angle and the chromaticity. Since people have an absolute judgment standard for angles, it becomes easy to depend on memory, and it is easy to establish correspondence between said parameter and color without having to use the legend.

Concretely, in the case of first weak color vision, although it is common to confuse red, yellow, and green, because of the angle, it is possible to predict colors by the angles roughly so that red is near the angle of 45 degrees, yellow is near the angle of 90 degrees, and green is near the angle of 135 degrees. If the correspondence is memorized, it is possible to judge to some extent the color without having to depend on the legend. Because of this, it also becomes easy to read out colors.

When this effect was experimented with, for four normal persons under test, when one day had passed after showing the legend and the persons were asked to judge based on the angle, the error was about 60% compared to the case of not being able to judge based on the angle.

### (C2) Others

In the above preferred embodiment, although the color confusion line was taken as a concrete example of the region in which the results of light reception on the light receiving side were similar and could not be discriminated, it is not necessarily restricted to this. For example, it is possible to apply this similarly even when it is not the shape of a line but is a band or a region having a specific area in the chromaticity diagram.

In this manner, in the case of a region having a specific area, according to the two-dimensional position within that region, it is possible to take measures by assigning a plurality of parameters, such as angle and duty ratio of hatching.

Further, in the above preferred embodiment, by using as textures according to the difference in the original colors, textures including patterns or hatching with different angles, textures having patterns or hatching with different contrasts, textures that change with time such as blinking at different periods, textures that move with different periods or speeds or in different directions, textures that move with different speeds and in different directions, distinguishing close to the original view equivalent to the observation by general color vision persons becomes possible in a condition suitable for observation by a weak color vision person.

Further, this type of effect can also be used when a general color vision person or camera observes or photographs images under a light source having special spectral distribution. In concrete terms, when there is a light source having two types of single color lights, it is only possible to see colors that connect to those chromaticity points in the chromaticity diagram. For other directions, by adding textures indicated in the present invention, it is possible distinguish the colors.

In the preferred embodiment described above, as textures, it is not only possible to use patterns, hatching, or, contrast, angle, blinking, or the like, of the patterns or hatching, but also, in the case of printed matter, or the like, it is possible to include touch feeling realizing projections and depressions. Because of this, according to the differences in the original colors, distinguishing close to the original view equivalent to the observation by general color vision persons becomes possible in a condition suitable for observation by weak color vision persons. In this case, if it is a display device, it is possible to realize by forming or changing the projections and depressions by the extent of projection of multiple pins, or in the case of printed matter, it is possible to realize smoothness or roughness using paints.

Further, although the above explanations were of concrete examples of obtaining easy distinguishing by adding textures to color regions that are difficult to distinguish in a chromatic image, the above preferred embodiment can also be applied to colors that are difficult to distinguish in achromatic colors (gray scale), or for colors that are difficult to distinguish in dark and light colors in a single color chromatic image, and it is possible to obtain the good effect by obtaining easy distinguishing.

### [D] Fourth Embodiment

### (D1) Configuration of an Information Conversion Apparatus

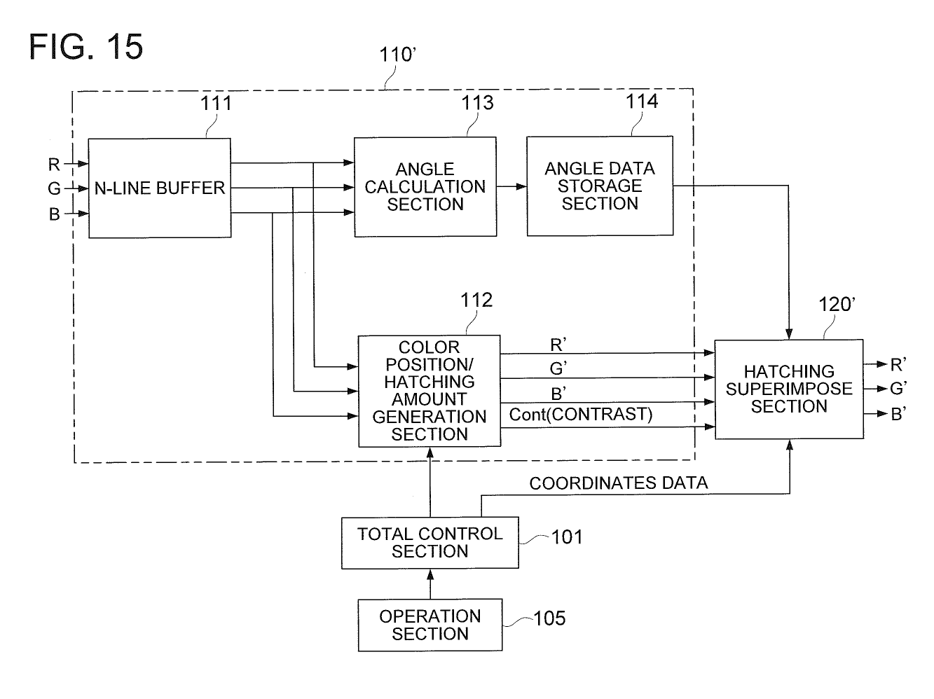

FIG. 14 is a flow chart showing the operations (the procedure of execution of the image processing method) of an information conversion apparatus 100′ according to a fourth preferred embodiment of the present invention and FIG. 15 is a block diagram showing the detailed configuration inside an information conversion apparatus 100′ according to a fourth preferred embodiment of the present invention.

In this fourth preferred embodiment, in order to visually recognize the angle of hatching, or the like, considering that an area equal to at least one cycle of slant lines is necessary, the image is divided into prescribed areas, and the hatching angle is determined for each representative value of the pixel value (color) of those areas. Because of this, since an area is present, there is the feature that visual recognition of the hatching angle inside that area becomes improved.

Further, although the following fourth preferred embodiment uses hatching as a concrete example of a texture, and concrete examples are described in which the hatching angle is determined for each of the prescribed areas, it is possible to apply this to the preferred embodiment described above. Therefore, duplicate explanations are omitted for the parts that are common to the preferred embodiment described above, and explanations are given mainly for the parts that are different from the preferred embodiment.

Also in the fourth embodiment, as described above, the intensity of the original image data can be reduced to eliminate a color shift caused by the saturation when an intensity modulation element such as hatching is added.

Further, in the block diagram of this information conversion apparatus 100′, descriptions have been made focusing on the periphery of the parts that are necessary for describing the operation of the present preferred embodiment, and explanations have been omitted for various known parts such as the power supply switch, power supply circuit, or the like, as in other information conversion apparatuses 100′.

The information conversion apparatus 100′ according to the present preferred embodiment is configured to have a control section 101 that executes the control for generating textures according to the color vision characteristics, a storage section 103 that stores the information, or the like, related to the color vision characteristics and the textures corresponding to them, an operation section 105 from which instructions related to the color vision characteristics information and the intensity modulation information are input by the operator, a intensity modulation processing section 110′ that generates, according to the image data, the color vision characteristics information, and the intensity modulation information, various textures with different conditions according to the difference in the original color regarding the regions on the color confusion line where, although the colors are different in the chromatic image, the results of light reception are similar in the light receiving side and hence it is difficult to distinguish, and a hatching synthesizing section 120′ that synthesizes and outputs the textures generated by the intensity modulation processing section 110′ and the original image data.

Further, here, the intensity modulation processing section 110′ is configured to be provided with an N-line buffer 111, a color position/hatching amount generation section 112, an angle calculation section 113, and an angle data storage section 114.

### (D2) Procedure of the Image Processing Method, Operation of the Apparatus, and Processing of the Image Processing Program

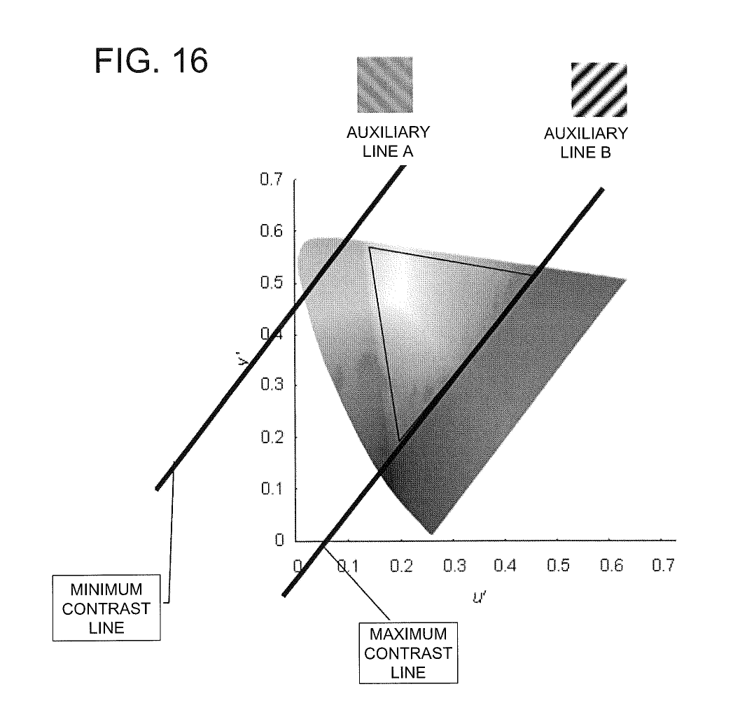

In the following, explanation of the operation of the fourth preferred embodiment is given referring to the flow chart of FIG. 14, the block diagram of FIG. 15, and the different types of diagrams of FIG. 16 and thereafter.

(D2-1) Image Area Segmentation:

To begin with, the N-line buffer 111 is prepared (Step S1201 in FIG. 14), and every N line of the RGB image data from an external apparatus is stored each time in that N-line buffer (Step S1202 in FIG. 14).

Here, at the time of adding textures of different angles corresponding to the differences in the original colors, the image data is segmented into areas configured from a plurality of pixels set in advance.

Although the method of segmenting this area depends on the resolution, it is desirable to segment in terms of every 8×8 to 128×128 pixels. This size becomes about 2 cycles/degree under standard observation conditions, and also, any power of 2 is desirable in order to make digital processing efficient.

Because of this, when the image is changing gradually, although the gradations are shown discretely, since the same angle is maintained as hatching within the same area, angles can be viewed accurately, and as a result, this leads to improvement in the ability to judge and recognize chromaticity.

(D2-2) Calculation of Representative Value in the Area:

As described above, the area is segmented, and in the angle calculation section 113, N pixels×N pixels are cut out (Step S1203 in FIG. 14), and the representative value is calculated for each of those areas.

As this representative value calculation, in order to carry it out easily, it is sufficient to take the average using the signal values of each pixel within the area. Further, it can also be a middle value or some other value.

Further, this area of N×N pixels can also be segmented further in terms of the color distribution. In this case, the segmentation is done into a plurality of areas (segments) and the representative value for each of those segments is obtained. Because of this, in the case the boundary of the image (the border part of color change) lies within a predetermined area, it is possible to make it a beautiful hatching without any artifacts. A general method of segmentation is used for segmenting the areas.

(D2-3) Hatching Parameter Calculation:

Next, the hatching parameter (angle/contrast) corresponding to the above representative value is obtained. Refer to FIG. 16 here.

In a uniform chromaticity diagram shown in FIG. 16 (for example, the u′v′ chromaticity diagram), a line that is substantially perpendicular to the color confusion line and that is also an auxiliary line that passes through the end of the color region is drawn (can be a straight line, a broken line, or a curved line). For example, the angle and contrast are made maximum on the auxiliary line B that passes through red and blue, and the angle and contrast are made minimum on the auxiliary line A that passes through green.

Further, in the angle calculation section 113 of the fourth preferred embodiment, the hatching parameter angle is determined based on the above auxiliary line A and the auxiliary line B. For example, the hatching angle is made equal to 45 degrees on the auxiliary line B passing through red and blue, and the hatching angle is made equal to 135 degrees on the auxiliary line A passing through green. In the preferred embodiment described above, since the determination was made from the boundary line of color gamut, there were locations in part, where there was sudden change. However, the triangle shown in the figure is an sRGB area, and green is passing approximately through the fundamental color green of AdobeRGB (a trademark or a registered trademark of Adobe Systems Inc. in USA and in other countries, same hereinafter).

(D2-4) Determining the Contrast Intensity:

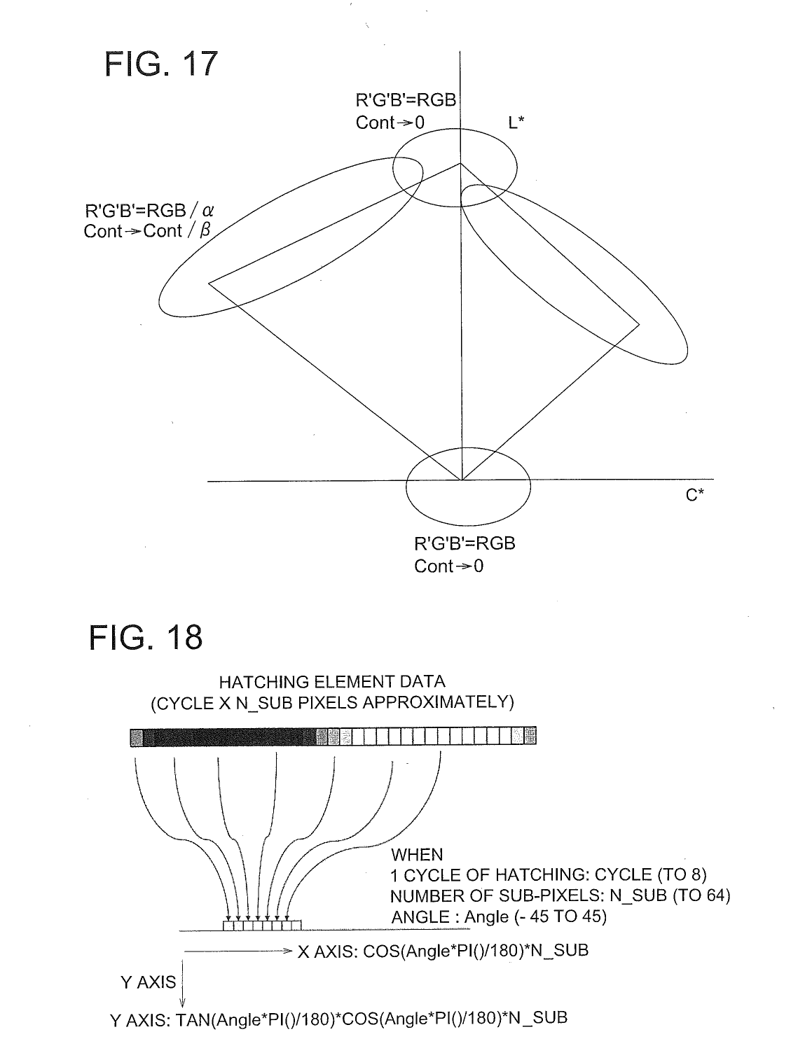

Here, the color position/hatching amount generation section 112 determines the intensity of contrast. Here, explanation is given referring to FIG. 17 (Step S1212 in FIG. 14). Further, here, the calculation is made not for the above described N×N pixels area but for each pixel.

Although, as a rule, the relationship is made proportional to the angle, at the color gamut boundary where there is no margin in the intensity direction, either the contrast intensity is made weak or the brightness of the original color is adjusted.

This is because, otherwise, when contrast is added to the original color, the pixel value will become saturated.

Near white or near black of the horizontal axis C*=0 in FIG. 17, since the likelihood of wrong recognition is low even without hatching, the contrast is weakened and made 0. In other words, R′G′B′ is made equal to RGB and Cont is made 0.

Further, in the part where the brightness L* is high excepting at C*=0, the intensity can be adjusted so that the target color is within the color gamut, and also, the contrast can be made weak. In other words, R′G′B′ is made equal to RGB/a and Cont is made equal to Cont/13.

(D2-5) Image Processing (Hatching Superimposition):

According to the parameters determined as above, in the hatching synthesizing section 120′, the hatching is superimposed. Here, explanations are given referring to FIG. 16.

Here, the elements constituting hatching image are taken in advance in one line. Even the information of sub-pixels is also recorded in this hatching element. This is called the hatching element data.

Based on the X axis value and the Y axis value at which hatching is to be superimposed, the data of an appropriate location is called from the hatching element data. In other words, hatching is generated by carrying out prescribed sampling from a sine curve. This is made dependent on the X coordinate, the Y coordinate, and the angle and the following equations is used for calculation, which is shown in FIG. 18. As a modified example, the part of the trigonometric functions can be calculated in advance and can be put in the form of a table, thereby making it possible to carry out the calculations at a high speed.

In other words, in the hatching synthesizing section 120′, the hatching information read out as above is superimposed on the image value according to the contrast intensity, thereby obtaining the new image data (Step S1207 in FIG. 14).

### (D-6) Modified Example

In the above processing, as a noise countermeasure, it is desirable that a low pass filter is applied to the chroma component thereby determining the contrast intensity.

Further, it is possible to change the intensity of the original color so that the difference can be understood slightly more, and thereafter if this method is applied, although the chromaticity is retained, the weak color vision persons can be made to recognize using the difference in intensity.

### (D-7) Effect of the Preferred Embodiment

### (D-7-1) Setting the Chromaticity and Angle

As the fourth preferred embodiment, for example, red and blue=hatching of 45 degrees, gray (achromatic)=hatching of 90 degrees, and green=hatching of 135 degrees is determined.

By doing so, since gray becomes a vertically upward angle (90 degrees), there is the advantage that it is easy to memorize the correspondence with the colors.

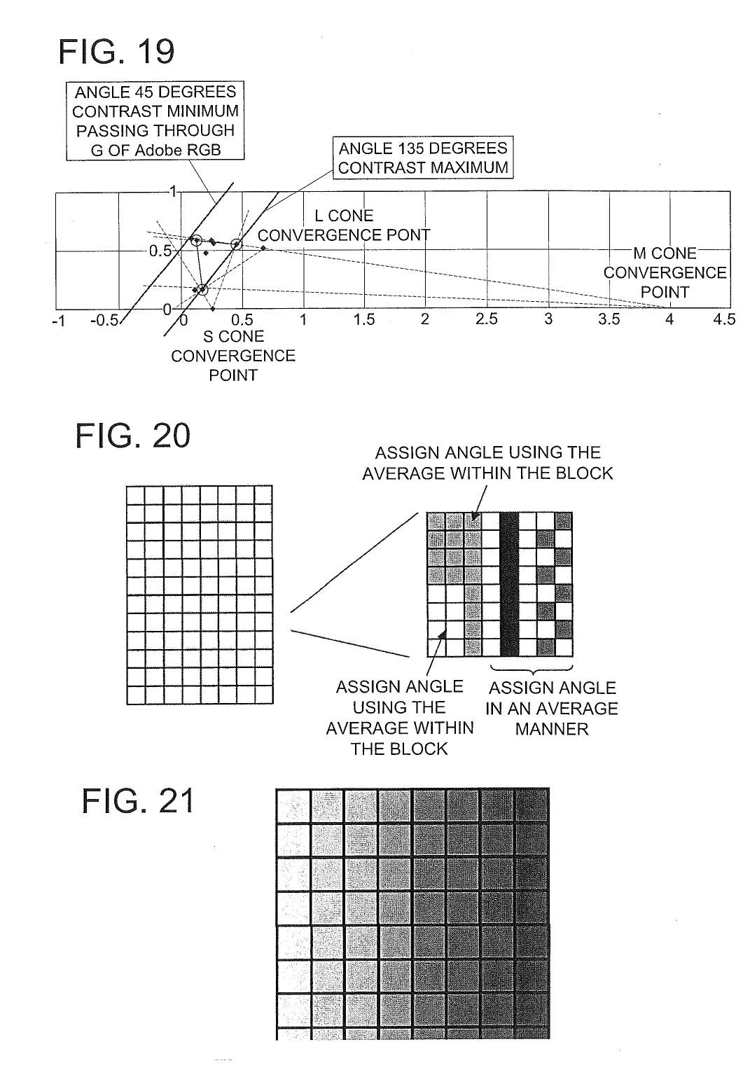

Here, as is shown in FIG. 19, the angle which covers the range of the color gamut from the convergence point of the color confusion line has been set so as to avoid the respective angles of the color confusion lines of the first weak color vision persons, the second weak color vision persons, and the third weak color vision persons. In other words, on the color confusion line of any weak color vision persons, the change in the hatching angle is made to be able to be observed. Because of this, it is made possible to be distinguished by all of the weak color vision persons.

Further, in this example, since gray has been set as the middle point, it is convenient to assume the green of AdobeRGB for green. Because of this, at the same time, it also becomes possible to accommodate to the colors of a broader color gamut.

Further, as will be described later, targeting all A-type weak color vision persons who can only recognize brightness, it is also possible to superimpose auxiliary hatching in the range of −45 degrees to +45 degrees. Because of this, it becomes possible to correspond to all types of weak color vision persons.

(D-7-2) Correspondence to Gradation/Noise/Dither Images “Setting of Segmentation”:

When the color has changed within the same grid area, it is judged as a plurality of colors as follows.

This algorithm is as follows.

Similar colors within the same area (for example, up to a difference of 5 in digital values) are present at the top, bottom, left and right, and the number of their connections is more than the number of pixels constituting the area, they are considered as segments, and an average color is assigned from all the pixels constituting it. The pixels that do not satisfy this are handled as exceptions, all the points of exception within a square block are collected together, and a comprehensive average color is assigned.

Further, as is shown in FIG. 20, if the pattern is a checkered pattern due to dither, or the like, or if it is simple vertical or horizontal pattern, since it appears visually as an average color, it has been determined not to treat as a segment.

Further, because of handing segments like these, hatching is done according to different colors neatly in the case of bar graphs, or the like, and in the case of gradations such as in FIG. 21, the hatching is done with the average inside the grid (within square blocks).

(D-7-3) Verification of Effects:

A concrete example of determining the hatching angle for each area of a prescribed number of pixels according to the above fourth preferred embodiment is described while referring to the drawings. Further, although the original is a color printed matter, at the time of making the patent application, it has been read out in monochrome.

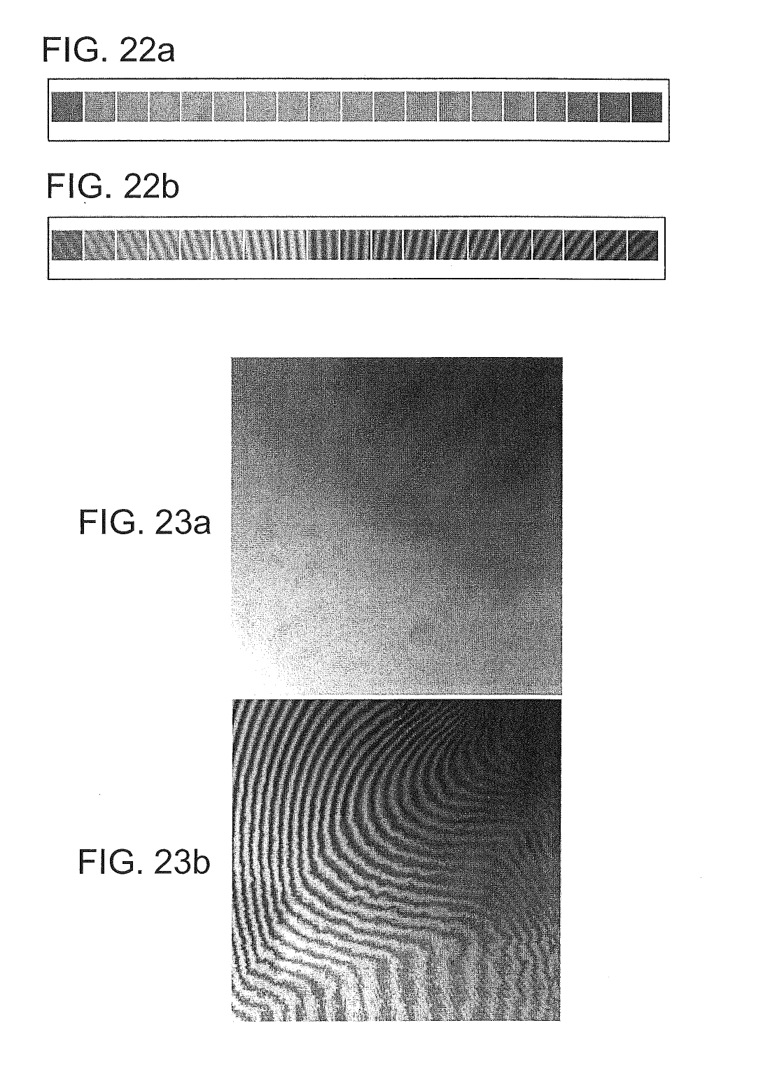

FIG. 22a, from left to right, shows 19 color charts that change gradually from green to red. FIG. 22b, from left to right, shows 19 color charts that change gradually from green to red with hatching added.

FIG. 23a is an image in which the color (chromatic) is changing gradually so that top left is magenta and bottom right is green, and also, gray (density of achromatic color) is changing gradually so that top right is black and bottom left is white.

FIG. 23b is an image which is made by adding hatching to FIG. 23a in units of one pixel by calculating the angle in units of one pixel, and shows the generation of moire pattern phenomenon, and it can be seen that there is a hatching angle different from the expected one at gray (should have been a hatching angle of 90 degrees) and green (should have been a hatching angle of about 120 degrees). Further, within the green region, there are areas in which there is a sudden change in the hatching angle that is not intended.

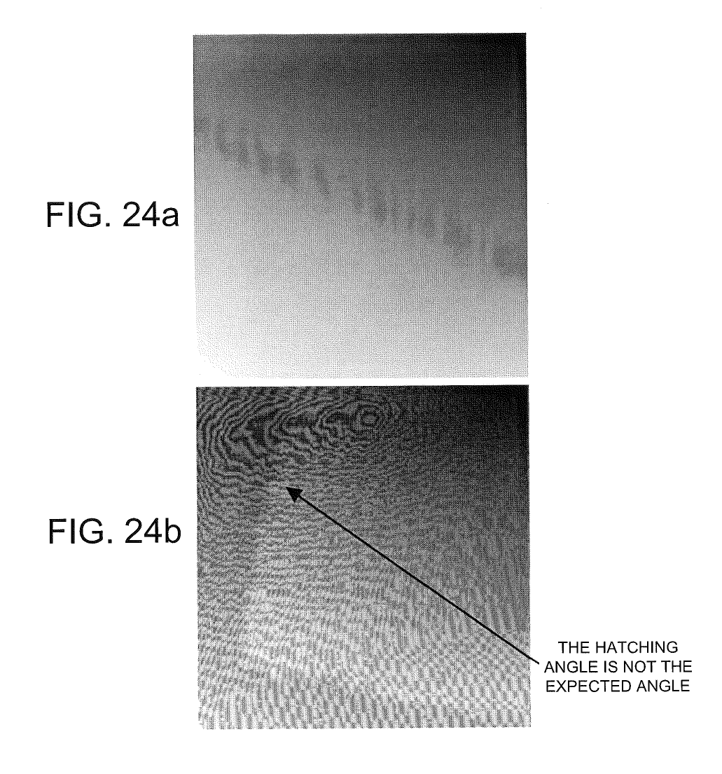

FIG. 24a is an image in which the color (chromatic) is changing gradually so that top left is red and bottom right is cyan, and gray (density of achromatic color) is changing gradually so that top right is black and bottom left is white.

FIG. 24b is an image which is made by adding hatching to FIG. 23a by calculating the angle in units of one pixel, and shows the generation of moire pattern phenomenon, and it can be seen that there is a state of a hatching angle greatly different from the intended one at red (should have been a hatching angle of about 45 degrees to 60 degrees).

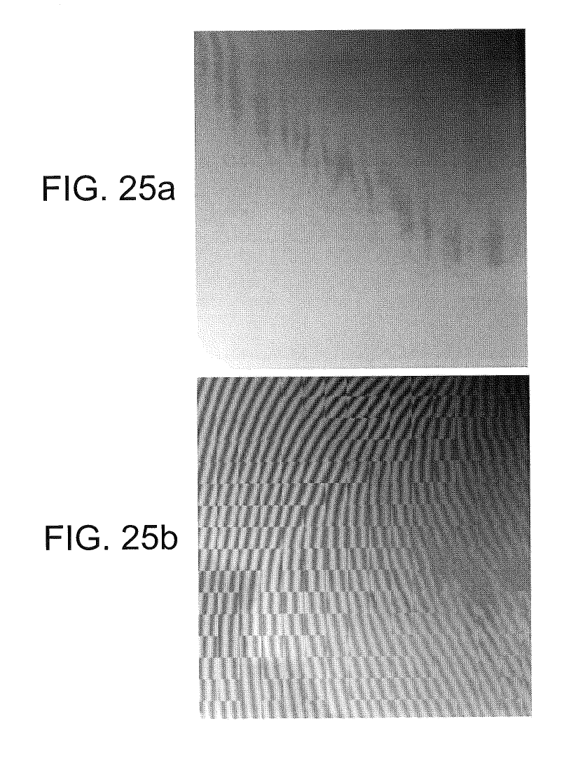

FIG. 25a is similar to FIG. 23a, and is an image in which the color is changing gradually (chromatic) so that top left is magenta and bottom right is green, and also, gray (density of achromatic color) is changing gradually so that top right is black and bottom left is white.

FIG. 25b is an image which is made by adding to FIG. 25a hatching with the angle calculated for every area having sixteen pixels, and the hatching is at an angle of 90 degrees for gray, the hatching angle is about 120 degrees for green, and the hatching angle is about 60 degrees for magenta, and can be viewed with the desired hatching angles. Further, there is no sudden change in the hatching angle.

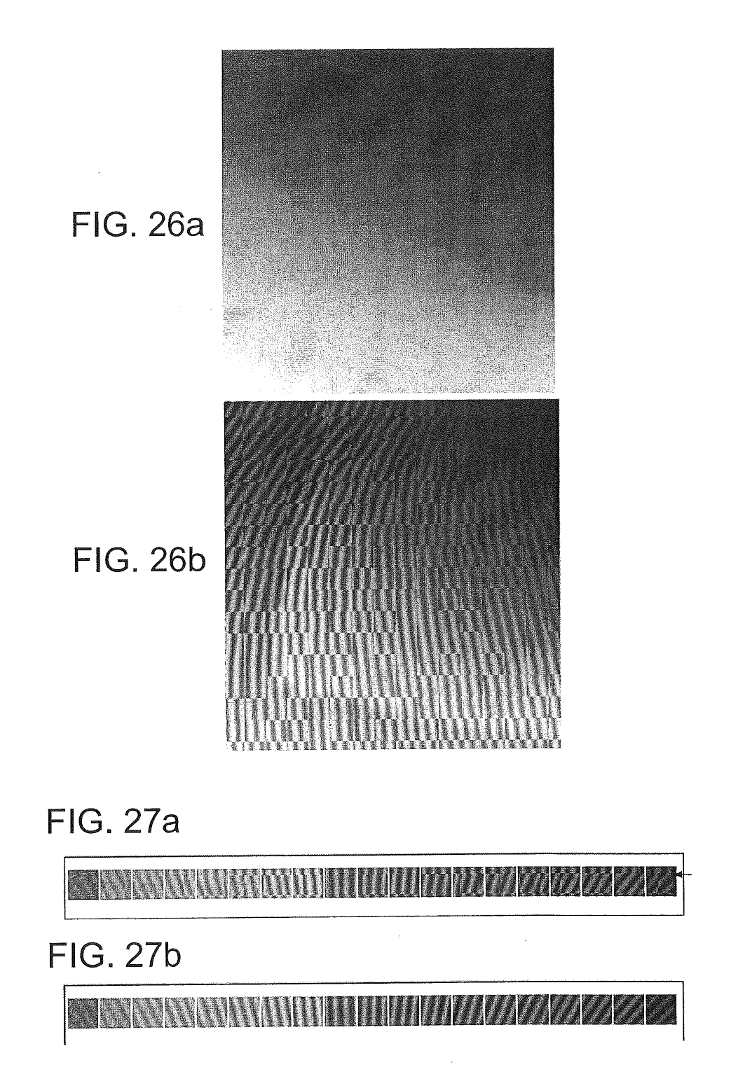

FIG. 26a is similar to FIG. 24a, and is an image in which the color (chromatic) is changing gradually so that top left is red and bottom right is cyan, and gray (density of achromatic color) is changing gradually so that top right is black and bottom left is white.

FIG. 26b is an image which is made by adding to FIG. 26a hatching with the angle calculated for every area having sixteen pixels, and the hatching is at an angle of 90 degrees for gray, the hatching angle is about 45 degrees for red, and the hatching angle is about 120 degrees for cyan, and can be viewed with the desired hatching angles. Further, there is no sudden change in the hatching angle.

Further, after carrying out experiments with various types of images not shown here in the figures, it was clear that it could be seen in the condition in which hatching with hatching angles similar to the hatching angles for the color charts shown in FIG. 22 was added to the image.

Further, according to the processing of segments described above, even when joints of hatching occur within the prescribed areas as shown in FIG. 27a, it is possible to make the hatching without the joints of hatching such as shown in FIG. 27b. Because of this it was confirmed that the degree of visual recognition of the angle of hatching had been increased further.

Further, in the fourth embodiment, similarly to the first embodiment, by reducing the intensity of original image data when the intensity modulation element is added, a preferred result can be obtained without a color shift caused by the saturation.

### [E] Fifth Embodiment

In the above first preferred embodiment and the fourth preferred embodiment, textures such as hatching were added to color images, thereby making it possible for both general color vision persons and persons with weak color vision to recognize the differences in color.

In contrast with this, in the fifth preferred embodiment, at the time of printing out color original document or color image data by monochrome printing, the feature is that the above first preferred embodiment and the fourth preferred embodiment are applied.

In other words, a monochrome image is finally formed by adding hatchings of different angles according to the differences in the colors. Because of this, the problem of distinction between colors being unable to be made due to monochrome printing will be solved. In this case, it is possible to realize the above by incorporating the circuit or program implementing the above preferred embodiments in the computer, or printer, or copying machine.

Because of this, it is possible to contribute to resource saving because it is possible to use monochrome printers efficiently, or, because the use of expensive color inks or color toners in color printers can be reduced.

Further, it is also possible to apply this fifth preferred embodiment to monochrome electronic papers that are coming into use in recent years such as displays with storage function using e-ink or the like.

Further, in color printers, there is the advantage that printing can be continued even when the color ink is exhausted and only black ink or black toner is remaining in a color printer.

Further, in color printers, even when one of the color inks or color toners has been exhausted, there is the advantage that printing can be continued even in the condition in which that color is not used by making that color to be recognized by the angle of the hatching.

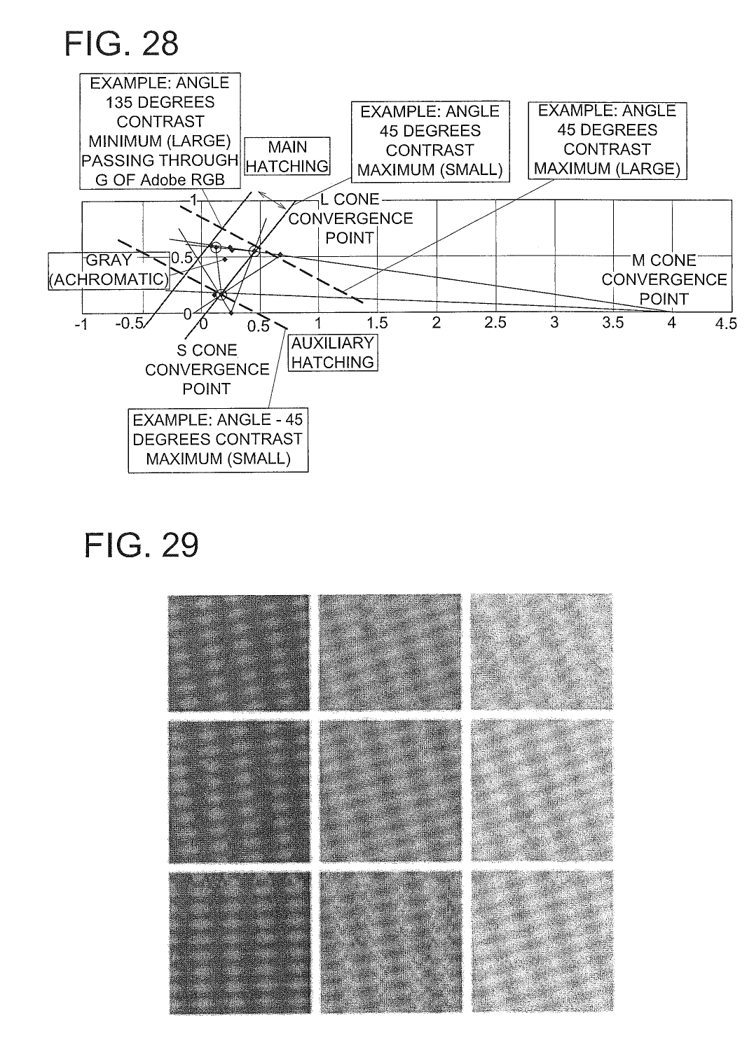

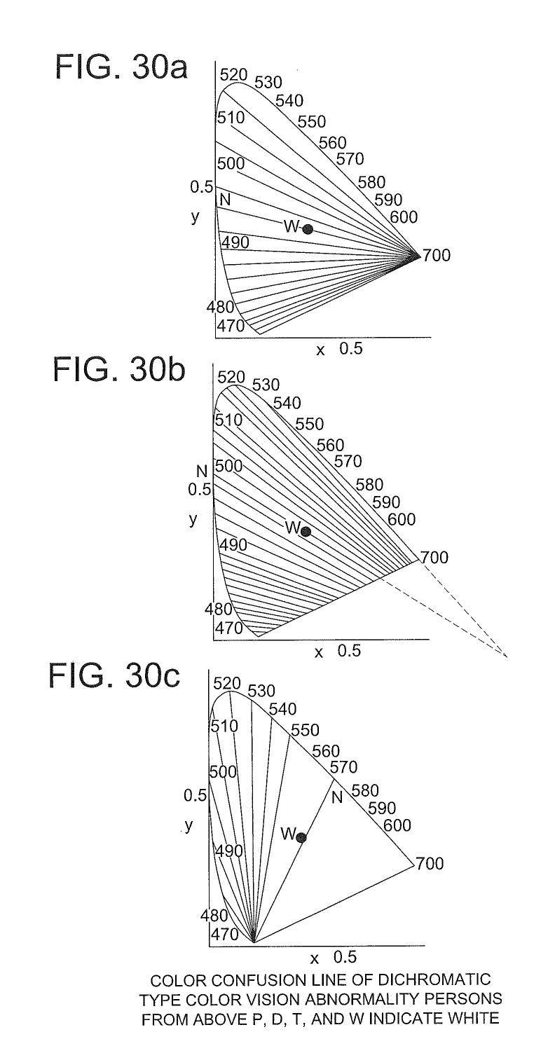

Further, at the time of carrying out this monochrome printing, in addition to the hatching in one direction (the main hatching) of the above preferred embodiment, it is desirable that a hatching (an auxiliary hatching) is added by calculating the hatching angle in a direction that is roughly at right angles to it (see FIG. 28).

Hatching is formed on the image by superimposing this auxiliary hatching on the main hatching. Because of this, it will be possible to distinguish between different colors even with monochrome printing or even for all A-type weak color vision persons.

At this time, in order to distinguish between auxiliary hatching and main hatching, the frequency or angle is made different in the auxiliary hatching compared to that in the main hatching.

It is desirable to make,

Main hatching: 45 to 135 degrees,

Auxiliary hatching: −45 to 45 degrees (or −30 to 30 degrees, in order to avoid overlapping). In addition, in the auxiliary hatching, it is desirable that the frequency is made higher than in the main hatching, thereby making it thinner. A frequency of twice the frequency in the main hatching is preferable. Because of this, it is possible to distinguish between the types of hatching.

Further, in the case of gray, it is desirable that the main hatching is made vertical while the auxiliary hatching is made horizontal in order to make the discrimination of colors easier.

Further, there are several patterns regarding the hatching intensity, and the following four combinations can be considered.
Main hatching: (1) Green being made strong, red being made weak. (2) The reverse of this.
Auxiliary hatching: (A) Blue being made strong, red being made weak. (B) The reverse of this.

(2) and (B), or (1) and (A) or (B) is desirable.

Since general color vision persons often use red as the color for attention, by making this kind of selection, it is possible to indicate even to persons with weak color vision as the part with high hatching intensity, that is, the color for attention. If the angle is fixed and this selection is appropriately changed depending on the type of image or the intentions of the document, there are no errors in discrimination between colors practically and it is possible to share the color for attention between general color vision persons and persons with weak color vision.

Further, as the hatching intensity, it is possible to take zero as near gray, and to increase the hatching intensity according to the distance from gray in the u′v′ chromaticity diagram for example.

FIG. 29 is an example showing the condition in which these types of main hatching and auxiliary hatching have been used together, and it can be seen that the bottom right is horizontal/vertical indicating the case of gray.

Further, in this embodiment, similarly to the first embodiment, by reducing the intensity of original image data when the intensity modulation element such as hatching is added, a preferred result can be obtained without an average density shift caused by the saturation.

### [F] Other Preferred Embodiments, Modified Examples

### (F1) Modification Example 1

In the case in which thin lines or characters are present in the original document, since the hatching has poor visibility, it is recommendable to make it possible to recognize by carrying out hatching as described above for a few pixels of the background including the thin lines. Because of this, for thin lines (for example, characters in red color), it is possible to make them recognizable by displaying that information by thin hatching in their surroundings.

### (F2) Modification Example 2

In the case in which the document has been generated electronically, the judgment for a uniform area, instead of judging by image processing for predetermined segmented areas, it is also recommendable to use the object information of the document. In this case, wrong judgment will not be caused because information such as shading is included.

### (F3) Modification Example 3

The technology in each of the above preferred embodiments can be used not only in documents or images but also in screens for operation, or the like, such as touch panels. In this case, it is also recommendable to have a structure by which the user is allowed to select the method, or the like, of adding hatching (contrast, or direction).

### (F4) Modification Example 4

When the present embodiment is to be performed while the original data is in color but the display is in monochrome, or while part of ink or toner is out, it is preferred that a mark or a note informing about the application of the technology of the present embodiment be added somewhere on the display or be printed on the paper. This prevents an observer from misunderstanding that the print to which the present embodiment has been applied is a defective display or that the display device has a problem.

### (F5) Modification Example 5

When the first area is to be extracted from an image that does not allow modification of the original, such as a barcode (a monochrome one-dimensional or two-dimensional QR code) or a color code using the arrangement of plural colors (a value display of an electronic component or a color-array code having information similarly to a barcode), this characteristic should be detected, and this area should not be specified as the first area. In other words, some codes have not only black but also plural colors, and even when the color is difficult to be recognized by a weak color vision person, hatching should not be allowed since modification is not permitted based on the nature of the code.

When the image is a color code, hatching may be added along with an identification mark indicating that it is a color code, upon recognition of the color code. Using parameter information such as inclination, intensity, and frequency of hatching, the processed image may be printed (displayed) as a hatching code; this may be an alternative to the color code or may allow standardization of the code. A conversion function for converting into colors from the identification mark or hatching may be added to a color code reading device (software).

### DESCRIPTION OF REFERENCE NUMERALS

100 The information conversion apparatus
101 Control section
103 Storage section
105 Operation section
110 First area extraction section
120 Second area determination section
130 First area color extraction section
140 Intensity modulation processing section
150 Image processing section
200 Display section

What is claimed is:

1. An information conversion method comprising the steps of:
extracting step for extracting a first area constituting a dot, a line or a character in an area of original image data, the area being able to be displayed;
extracting step for extracting a color of the first area;
determining a second area constituting a periphery of the first area;
generating an intensity modulation element whose intensity has been modulated in accordance with the color of the first area; and adding the intensity modulation element to the second area or to the first and the second areas for output.

2. The information conversion method of claim 1,
wherein, in the first area extracting step, when a width of the dot, the line or a line constituting the character is a prescribed value or less compared to a spatial wavelength of the intensity modulation element, the dot, the line or the character is extracted as the first area.

3. The information conversion method of claim 1,
wherein the intensity modulation element is a texture including a pattern or hatching, which is varied in accordance with a difference in an original color when the color is different but a result of light reception at a light receiving side is similar.

4. The information conversion method of claim 1,
wherein the intensity modulation element is a texture including a pattern or hatching, which has different inclination in accordance with a difference in an original color when the color is different but a result of light reception at a light receiving side is similar.

5. The information conversion method of claim 1,
wherein the intensity modulation element changes intensity of a color while keeping chromaticity of the color unchanged.

6. An information conversion apparatus comprising:
a first area extraction section for extracting a first area constituting a dot, a line or a character in an area of original image data, the area being able to be displayed;
a first area color extraction section for extracting a color of the first area;
a second area determination section for determining a second area constituting a periphery of the first area;
an intensity modulation processing section for generating an intensity modulation element whose intensity has been modulated in accordance with the color of the first area through intensity modulation processing; and
an image processing section for adding the intensity modulation element to the second area or to the first and the second areas for output.

7. The information conversion apparatus of claim 6,
wherein when a width of the dot, the line or a line constituting the character is a prescribed value or less compared to a spatial wavelength of the intensity modulation element, the first area extraction section extracts the dot, the line or the character as the first area.

8. The information conversion apparatus of claim 6,
wherein the intensity modulation element is a texture including a pattern or hatching, which is varied in accordance with a difference in an original color when the color is different but a result of light reception at a light receiving side is similar.

9. The information conversion apparatus of claim 6,
wherein the intensity modulation element is a texture including a pattern or hatching, which has different inclination in accordance with a difference in an original color when the color is different but a result of light reception at a light receiving side is similar.

10. The information conversion apparatus of claim 6,
wherein the intensity modulation element changes intensity of a color while keeping chromaticity of the color unchanged.

11. A computer-readable recording medium having an information conversion program stored therein to be executed by a computer,
the information conversion program allowing the computer to function as:
a first area extraction section for extracting the first area constituting a dot, a line or a character in an area of original image data, the area being able to be displayed;
a first area color extraction section for extracting a color of the first area;
a second area determination section for determining a second area constituting a periphery of the first area;
an intensity modulation processing section for generating an intensity modulation element whose intensity has been modulated in accordance with the color of the first area through intensity modulation processing; and
an image processing section for adding the intensity modulation element to the second area or to the first and the second areas for output.
